(19) United States
(12) Patent Application Publication
(10) Pub. No.: US 2015/0267033 A1
(43) Pub. Date: Sep. 24, 2015

(54) IONOMER COMPOSITE

(71) Applicant: E.I. DU PONT DE NEMOURS AND COMPANY, Wilmington, DE (US)

(72) Inventors: Gordon Mark Cohen, Wynnewood, PA (US); Richard Allen Hayes, Beaumont, TX (US); Mark David Wetzel, Newark, DE (US)

(21) Appl. No.: 14/433,926

(22) PCT Filed: Oct. 10, 2013
(86) PCT No.: PCT/US13/64207

§ 371 Date: Apr. 7, 2015

Related U.S. Application Data
(60) Provisional application No. 61/712,852, filed on Oct. 12, 2012.
(60) Provisional application No. 61/712,857, filed on Oct. 12, 2012.
(60) Provisional application No. 61/712,866, filed on Oct. 12, 2012.
(60) Provisional application No. 61/712,873, filed on Oct. 12, 2012.
(60) Provisional application No. 61/713,037, filed on Oct. 12, 2012.
(60) Provisional application No. 61/713,021, filed on Oct. 12, 2012.
(60) Provisional application No. 61/713,027, filed on Oct. 12, 2012.

(51) Int. Cl. C08K 3/34; C08K 5/20; C08L 33/10; C08L 23/06; C08L 33/02; C08L 77/00; C08K 5/3415; C08K 5/05

(52) U.S. Cl. CPC C08K 3/34; C08K 5/3415; C08K 5/20; C08K 5/05; C08L 23/06; C08L 33/02; C08L 77/00; C08L 33/10

(57) ABSTRACT

An ionomer composite comprises a partially neutralized acid copolymer that comprises copolymerized units of an α-olefin having 2 to 10 carbons and units of an α,β-ethylenically unsaturated carboxylic acid having 3 to 8 carbons and a nanoscale filler material that are mutually dispersible in an aqueous medium. The ionomer composite itself may be formed into an article of manufacture or let down in a host polymer to form a multipolymer composite. The resulting materials may exhibit a combination of one or more desirable characteristics, including low haze, absence of undesirable coloration, high toughness, high scratch resistance, low creep, reduced coefficient of thermal expansion, and higher modulus.

### CROSS REFERENCE TO RELATED APPLICATIONS

Subject matter disclosed herein is related to subject matter disclosed in the following copending applications: “Ionomer Composite,” U.S. Ser. No. 61/712,852; “Ionomer Composite,” U.S. Ser. No. 61/712,857; “Ionomer Composite,” U.S. Ser. No. 61/712,866; “Ionomer Composite,” U.S. Ser. No. 61/712,873; “Solar Cell Module Having An Encapsulant Layer Comprising A Nanoparticulate Filler,” U.S. Ser. No. 61/713,037; “Glass Laminates With Nanofilled Ionomer Interlayers,” U.S. Ser. No. 61/713,021; and “Articles Prepared From Nanofilled Ionomer Compositions,” U.S. Ser. No. 61/713,027. Said applications were all filed on Oct. 12, 2012, are assigned to the assignee of the present invention, and are all incorporated herein in the entirety for all purposes by reference thereto.

### TECHNICAL FIELD

This subject matter hereof relates to composite materials and, more particularly, to a composition of matter, a composite body formed therewith, and a method for producing the composite body. The composition comprises an ionomer and particulate filler material dispersed therein, which are optionally dispersed in another host polymer.

### BACKGROUND

It is common in the plastics industry to blend various additives with a matrix polymer for the purpose of improving one or more polymer physical properties. Polymer systems containing filler additives are well-known items of commerce. Inclusion of fillers of various types has been shown to improve certain properties of the base polymer matrix, including one or more of the modulus, stiffness, and hardness. Both microscale and nanoscale fillers have been considered, and have led in some instances to desired improvements.

For example, U.S. Pat. No. 7,270,862 discloses combinations of nanofillers and polyolefins that impart improved barrier properties to polyamide compositions. Such compositions contain nanofillers dispersed in a polymer matrix and are referred to as nanocomposites.

However, the improvement in properties is often thwarted by an inability to disperse the additives with sufficient uniformity in these composites. In some cases, poor dispersion even results in degradation of certain desirable properties, such as strength and toughness and optical clarity. In other systems there are no known ways of preparing a dispersion whatsoever or the filler particles do not adequately bond with the matrix polymer. In either instance, desirable improvements in properties are not obtained.

The difficulty of obtaining a good dispersion typically increases as particle size decreases, especially for nanoscale particles. For example, it is known that the propensity for agglomeration and/or aggregation increases as particle size decreases.

There remains a need in the art for techniques that permit formation of composite compositions with a wider range of matrix polymers and a wider range of composition and size of particulate additives.

### SUMMARY

An aspect of the present invention provides a composition of matter comprising:

(a) an ionomer composition comprising a parent acid copolymer that comprises copolymerized units of an α-olefin having 2 to 10 carbons and units of an α,β-ethylenically unsaturated carboxylic acid having 3 to 8 carbons, wherein a portion of the carboxylic acid groups of the parent acid copolymer are neutralized by cations to form carboxylate salts, the cations being monovalent metal cations, ammonium cations, or any mixture thereof; and

(b) a filler material comprising hydrophilic nanoparticles that are substantially free of organoammonium, organophosphonium, and organosulfonium compounds,

and wherein the ionomer composition and the filler are mutually dispersible in an aqueous medium.

Another aspect provides a multipolymer composite, comprising:

(a) a host polymer;

(b) an ionomer composition comprising a parent acid copolymer that comprises copolymerized units of an α-olefin having 2 to 10 carbons and units of an α,β-ethylenically unsaturated carboxylic acid having 3 to 8 carbons, wherein a portion of the carboxylic acid groups of the parent acid copolymer are neutralized by monovalent cations to form carboxylate salts, the monovalent cations being monovalent metal cations, ammonium cations, or any mixture thereof; and

(c) a filler comprising hydrophilic nanoparticles that are substantially free of organoammonium, organophosphonium, and organosulfonium compounds,

and wherein the ionomer composition and the filler are mutually dispersible in an aqueous medium and the ionomer composition and filler are dispersed in the host polymer.

### BRIEF DESCRIPTION OF THE DRAWINGS

The invention will be more fully understood and further advantages will become apparent when reference is had to the following detailed description of the preferred embodiments of the invention and the accompanying drawing, in which:

FIGS. 1A-1E are TEM images of composites incorporating Laponite® OG synthetic hectorite in certain K⁺ and Na⁺ neutralized ionomers;

FIGS. 2A and 2B are TEM images of 9 wt. % Laponite® OG synthetic hectorite composites prepared using 25:75 and 50:50 IPA/water mixtures to disperse the nanofiller;

FIG. 3 is a TEM image of a composite comprising 19 wt. % Laponite® OG synthetic hectorite in poly(ethylene-acrylic acid) ammonium ionomer;

FIG. 4 is a TEM image of an ionomer composite comprising 18 wt. % Laponite® RD synthetic hectorite;

FIG. 5 is a TEM image of an ionomer composite comprising 18 wt. % Laponite® B synthetic hectorite;

FIG. 6 is a TEM image of an ionomer composite comprising 18 wt. % Laponite® JS synthetic hectorite;

FIG. 7 is a TEM image of an ionomer composite comprising 9 wt. % of colloidal silica from Ludox® TM-40;

FIG. 8 is a TEM image of an ionomer composite comprising 9 wt. % colloidal silica from Ludox® TMA;

FIG. 9 is a TEM image of an ionomer composite comprising 9 wt. % colloidal silica from Ludox® CL;

FIG. 10 is a TEM image of an ionomer composite comprising 9 wt. % sepiolite;

FIG. 11 is a TEM image of an ionomer composite comprising 2 wt. % graphene oxide;

FIG. 12 provides TEM images at two magnifications of an ionomer composite pellet sample made by a one-step direct melt compounding process with slurry injection and water removal;

FIGS. 13A-13C provides TEM images at two magnifications each of masterbatches containing 25 wt. % synthetic hectorite sample dispersed respectively in K⁺ and Na⁺ neutralized, water-dispersible ionomers and a mixture thereof;

FIGS. 14A-14D are TEM images of multipolymer composites in which a masterbatch comprising a synthetic hectorite nanofiller dispersed in a water-dispersible ionomer has been let down in an ethylene copolymer;

FIG. 15 is a TEM image of a multipolymer composite prepared by let-down of a masterbatch comprising a synthetic hectorite nanofiller dispersed in a water-dispersible ionomer into another ionomer;

FIGS. 16A and 16B are TEM images (taken at the same magnification) of different portions of a multipolymer composite prepared by let-down of a masterbatch comprising a synthetic hectorite nanofiller dispersed in a water-dispersible ionomer into still another ionomer;

FIG. 17 is a TEM image of a multipolymer composite prepared by let-down of a masterbatch comprising a synthetic hectorite nanofiller dispersed in a water-dispersible ionomer into yet another ionomer;

FIG. 18 is a TEM image of a dry powder providing a masterbatch comprising 30 wt. % colloidal silica in a water-dispersible ionomer;

FIGS. 19A-19D are TEM images of multipolymer composites prepared using masterbatches comprising a colloidal silica nanofiller dispersed in a water-dispersible ionomer that has been let down into two other ionomers at different nanoparticle loadings;

FIG. 20 is a TEM image of a masterbatch comprising a synthetic hectorite nanofiller in a water-dispersible ionomer, prepared using a dilute solution processing method with dispersal in a mixed IPA/water medium;

FIG. 21 is a TEM image of a multipolymer composite comprising an ionomer, synthetic hectorite filler, and a nylon 66 polyamide matrix;

FIGS. 22A and 22B are TEM images of a multipolymer composite comprising an ionomer, synthetic hectorite filler, and an ethylene methyl acrylate copolymer matrix; and

FIG. 23 is a TEM image of an injection-molded tensile bar comprising synthetic hectorite nanofiller derived from an ionomer masterbatch let down into linear, low density polyethylene.

FIG. 24 is a TEM image of a nanocomposite comprising 9 wt % Laponite® OG in KOH-neutralized poly(methyl methacrylate/methacrylic acid).

### DETAILED DESCRIPTION

Several patents, patent applications, and publications are cited in this description in order to more fully describe the present invention. The entire disclosure of each of these patents, patent applications and publications is incorporated by reference herein.

Unless otherwise defined, all technical and scientific terms used in the present specification and subjoined claims have the same meaning as commonly understood by one of ordinary skill in the art to which this invention belongs. In case of conflict, this specification, including definitions set forth herein, will control.

It should be understood that in some instances herein, polymers are described by referring to the monomers or the amounts thereof used to produce the polymers. While such a description may not include the specific nomenclature used to describe the final polymer or may not contain product-by-process terminology, any such reference to monomers and amounts should be interpreted to mean that the polymer comprises those monomers (i.e. copolymerized units of those monomers) or that amount of the monomers, and the corresponding polymers and compositions thereof.

In describing and/or claiming this invention, the term “copolymer” is used to refer to polymers formed by copolymerization of two or more monomers. Such copolymers include dipolymers, terpolymers, or higher order copolymers.

The term “acid copolymer” as used herein refers to a polymer comprising copolymerized units of an α-olefin and an α,β-ethylenically unsaturated carboxylic acid, and, optionally, other suitable comonomer(s) such as an α,β-ethylenically unsaturated carboxylic acid ester.

The term “ionomer” as used herein refers to a polymer that comprises ionic groups that are carboxylates of cations that include, without limitation, one or more of alkali metal, alkaline earth metal, transition metal, and ammonium cations. Such polymers are generally produced by partially or fully neutralizing the carboxylic acid groups of a precursor or “parent” polymer that is an acid copolymer, as defined herein, for example by reaction with a base. Ionomers are often denominated by the cation used to effect the carboxylic acid neutralization. As an example, neutralizing at least a portion of the carboxylic acid groups of a copolymer of ethylene and methacrylic acid using sodium hydroxide produces a sodium ionomer (or sodium neutralized ionomer) comprising sodium carboxylates.

As used herein, the nomenclature “(meth)acrylate” refers collectively to both acrylates and methacrylates. Similarly, the adjective “(meth)acrylic” is understood to mean either “acrylic” or “methacrylic.”

In an aspect of the present disclosure, there is provided a composition of matter comprising a base polymer (also herein termed a carrier polymer) and a nanoscale filler material that are mutually dispersible in an aqueous medium. By “mutually dispersible” is meant that a suspension or solution of the constituents can be created that is both sufficiently stable to allow further processing and able to be dried without loss of dispersion of the filler material in the polymer. For example, polyethylene glycol and certain platy silicate nanofiller materials are both individually dispersible in an aqueous medium. However, when a combination of these materials is dried, the dispersion of the silicate is lost. Water-soluble polyethylene oxide behaves similarly.

In some embodiments, the foregoing composition of matter, comprising a base polymer and a nanoscale filler material that are mutually dispersible in an aqueous medium, is itself useful as an ionomer composite, wherein nanoparticles derived from the nanoscale filler material are dispersed in the ionomer. Such a composition may be formed subsequently into an article of manufacture using known techniques, such as injection molding, extrusion, transfer molding, and compression molding. The constituents of the composition also can be combined during a unitary processing appointed to produce an article of manufacture, either in a net shape or near net shape, or as a stock shape to be formed into a final desired shape.

In a further aspect, the foregoing composition of matter is prepared as a masterbatch that can function as a carrier for the nanofiller in subsequent processing, wherein the masterbatch is let down either (a) in an additional amount of the same base polymer; or (b) in another host polymer to form a multipolymer composite.

A still further aspect of the present disclosure provides an alloyed multipolymer composite, wherein the foregoing multipolymer composite is further combined with an alloying polymer different from the host polymer.

Yet other aspects provide methods for manufacturing the present composition of matter, a masterbatch thereof, a multipolymer composite, an alloyed multipolymer composite, and articles made with the composition of matter, the multipolymer composite, or the alloyed multipolymer composite.

### Acid Copolymers and Ionomers

The base polymer of the present composition of matter is provided by an ionomer composition that is an ionic, partially neutralized derivative of a parent acid copolymer (alternatively termed a precursor acid copolymer) that comprises copolymerized units of an α-olefin and units of an α,β-ethylenically unsaturated carboxylic acid. Examples of suitable ionomers include those described in U.S. Pat. No. 7,763,360 and U.S. Patent Application Publication 2010/0112253, for example.

In an embodiment, the α-olefin units of the precursor acid copolymer have 2 to 10 carbons and the α,β-ethylenically unsaturated carboxylic acid units have 3 to 8 carbons. The amount of copolymerized α-olefin is complementary to the amount of copolymerized α,β-ethylenically unsaturated carboxylic acid and of other comonomer(s), if present, so that the sum of the weight percentages of the comonomers in the precursor acid copolymer is 100%. In representative, non-limiting embodiments, the precursor acid copolymer comprises about 15 to about 30 wt. %, or about 18 to about 25 wt. %, or about 19 to about 23 wt. % of copolymerized units of the α,β-ethylenically unsaturated carboxylic acid.

Suitable α-olefin comonomer units include, but are not limited to, ethylene, propylene, 1-butene, 1-pentene, 1-hexene, 1-heptene, 3 methyl-1-butene, 4-methyl-1-pentene, and the like, and mixtures of two or more thereof. In one possible embodiment, the α-olefin is ethylene.

Suitable α,β-ethylenically unsaturated carboxylic acid comonomer units include, but are not limited to, acrylic acids, methacrylic acids, itaconic acids, maleic acids, maleic anhydrides, fumaric acids, monomethyl maleic acids, and mixtures of two or more thereof. In possible embodiments, the α,β-ethylenically unsaturated carboxylic acid is selected from acrylic acids, methacrylic acids, and mixtures thereof.

In an embodiment, the α,β-ethylenically unsaturated carboxylic acid is methacrylic acid. Of note are acid copolymers consisting essentially of copolymerized units of ethylene and units of the α,β-ethylenically unsaturated carboxylic acid without addition of additional comonomers; that is, dipolymers of ethylene and the α,β-ethylenically unsaturated carboxylic acid. In various embodiments, the acid copolymers of the present ionomer composition are ethylene methacrylic acid dipolymers, ethylene acrylic acid dipolymers, or a mixture thereof.

Optionally, the precursor acid copolymer further comprises one or more other comonomers in an amount up to about 20 wt. %, up to about 40 wt. %, or in an amount of about 5 to 20 wt. %. For example, the precursor acid copolymer may further comprise copolymerized units of unsaturated carboxylic acids having 2 to 10, or preferably 3 to 8 carbons, or derivatives thereof, including without limitation one or more of an alkyl acrylate or methacrylate having at most 8 carbons, an alkyl ester of maleic or fumaric acid having at most 8 carbons, or maleic anhydride. The presence of other comonomers is optional, however, and in some implementations it is preferable that the precursor acid not include any other comonomer(s).

If used, suitable acid derivative comonomers include, without limitation, acid anhydrides, amides, and esters. Specific examples of such esters of unsaturated carboxylic acids include, but are not limited to, alkyl (meth)acrylates, other (meth)acrylate esters; vinyl acetate; maleic anhydride; and alkyl hydrogenate maleates. Examples of such materials include methyl acrylates, methyl methacrylates, ethyl acrylates, ethyl methacrylates, propyl acrylates, propyl methacrylates, isopropyl acrylates, isopropyl methacrylates, butyl acrylates, butyl methacrylates, isobutyl acrylates, isobutyl methacrylates, tert-butyl acrylates, tert-butyl methacrylates, octyl acrylates, octyl methacrylates, undecyl acrylates, undecyl methacrylates, octadecyl acrylates, octadecyl methacrylates, dodecyl acrylates, dodecyl methacrylates, 2-ethylhexyl acrylates, 2-ethylhexyl methacrylates, isobornyl acrylates, isobornyl methacrylates, lauryl acrylates, lauryl methacrylates, 2-hydroxyethyl acrylates, 2-hydroxyethyl methacrylates, glycidyl acrylates, glycidyl methacrylates, poly(ethylene glycol)acrylates, poly(ethylene glycol)methacrylates, poly(ethylene glycol) methyl ether acrylates, poly(ethylene glycol) methyl ether methacrylates, poly(ethylene glycol) behenyl ether acrylates, poly(ethylene glycol) behenyl ether methacrylates, poly(ethylene glycol) 4-nonylphenyl ether acrylates, poly(ethylene glycol) 4-nonylphenyl ether methacrylates, poly(ethylene glycol) phenyl ether acrylates, poly(ethylene glycol) phenyl ether methacrylates, dimethyl maleates, diethyl maleates, dibutyl maleates, dimethyl fumarates, diethyl fumarates, dibutyl fumarates, dimethyl fumarates, vinyl acetates, vinyl propionates, and mixtures of two or more thereof. Examples of preferable suitable comonomers include, but are not limited to, methyl acrylates, methyl methacrylates, butyl acrylates, butyl methacrylates, glycidyl methacrylates, vinyl acetates, and mixtures of two or more thereof.

The precursor acid copolymers may be polymerized in any suitable manner, including approaches disclosed in U.S. Pat. Nos. 3,404,134; 5,028,674; 6,500,888; and 6,518,365. Preferably, the precursor acid copolymers are polymerized under process conditions such that short chain and long chain branching is maximized. Such processes are disclosed in, e.g., P. Ehrlich and G. A. Mortimer, “Fundamentals of Free-Radical Polymerization of Ethylene”, Adv. Polymer Sci., Vol. 7, p. 386-448 (1970) and J. C. Woodbrey and P. Ehrlich, “The Free Radical, High Pressure Polymerization of Ethylene II. The Evidence For Side Reactions from Polymer Structure and Number Average Molecular Weights”, J. Am. Chem. Soc., Vol. 85, p. 1580-1854 (1963).

The acid-neutralized ionomer useful in the present nanofilled ionomer composition may be prepared by reacting a suitable precursor acid copolymer with a preselected base to provide an ionomer that is neutralized to any extent compatible with the requirement of water dispersibility, as discussed hereinbelow. In various embodiments, about 40% to about 95%, or about 50% to about 80%, or about 50% to about 70% of the hydrogen atoms of carboxylic acid groups of the precursor acid are replaced by monovalent cations. That is, the acid groups are neutralized to a level of about 40% to about 90%, about 50% to about 80%, or preferably about 50% to about 70%, based on the total carboxylic acid content of the precursor acid copolymers as calculated or measured for the non-neutralized precursor acid copolymers. Possible neutralization processes are disclosed, for example, in U.S. Pat. No. 3,404,134.

In various embodiments of the present disclosure, the cations used to neutralize the carboxylic acids are monovalent and are any one or more of the alkali metal cations (Li⁺, Na⁺, K⁺, Rb⁺, or Cs⁺), monovalent transition metal cations, or NH₄⁺. For the sake of cost and performance, Na⁺ and K⁺ are used most commonly. In an implementation, the cations consist essentially of Na⁺ cations or consist essentially of K⁺ cations.

In an implementation, the parent acid copolymers used herein have a high melt flow rate (MFR) prior to neutralization, e.g., an MFR of about 200 to about 1000 grams/10 min as measured at 190° C. using a 2160 g load in accordance with the method provided by ASTM D1238. Alternatively, the parent acid copolymers have MFR from a lower limit of any of 30, 60, 100, 200, 250 or 300 to an upper limit of any of 400, 500, 600 or 1000. (ASTM Standard D1238-10 is promulgated by ASTM International, West Conshohocken, Pa., and is incorporated herein by reference. A similar test is specified by ISO 1133. Unless otherwise stated, melt flow rates set forth herein are all measured in accordance with the foregoing D1238 protocol. Melt flow rate is sometimes termed “melt index” or “MI.”)

The combination of the above described melt flow rates of the parent acid copolymer and the neutralization levels provides ionomers that are readily self-dispersible in water or other aqueous medium, without the need for the high-shear mixing and/or the elevated temperatures previously required to attain dispersion. A “water-dispersible polymer” is one that forms a colloidal suspension of particles that may possibly be swollen by water. A “water-soluble polymer” is one that dissolves in water to form a molecular solution. A skilled person will recognize that some portion of a polymer ordinarily regarded as being “water-dispersible” may, in fact, dissolve when the polymer is dispersed in water. In some embodiments, ionomers useful in the present composition are dispersible in hot water, such as water at 90° C. or more.

In different embodiments, the water-dispersible ionomer useful in practicing the present disclosure has any one or more of the following features, or any combination thereof: (i) about 15 to about 30 weight % of copolymerized units of acrylic acid or methacrylic acid, based on the total weight of the parent acid copolymer; (ii) a melt flow rate (MFR) between about 200 and about 1000 g/10 min of the parent acid copolymer before neutralization; and (iii) about 50% to about 70% of the carboxylic acid groups of the copolymer, based on the total carboxylic acid content of the acid copolymer as calculated for the unneutralized copolymer being neutralized to carboxylic acid salts.

Other such embodiments feature one or more of: (i) about 15 to about 30 weight % of copolymerized units of (meth)acrylic acid in an amount from a lower limit to an upper limit, the lower limit being any of 15, 18, or 19 wt. % and the upper limit being any of 30, 25, or 23 wt. %; (ii) an MFR from a lower limit to an upper limit, the lower limit being any of 200, 250, or 300 g/10 min and the upper limit being any of 400, 500, 600 or 1000 g/10 min; and (iii) a neutralization level from a lower limit to an upper limit of the portion hydrogen atoms of carboxylic acid groups of the precursor acid replaced by monovalent cations, the lower limit being either of 40% or 50% and the upper limit being any of 70%, 80%, 90%, 95%, or even approximately 100%.

Use of a parent acid copolymer having any of the foregoing combinations of properties permits formulation of an ionomer composite with optimum physical properties for a variety of end uses, either in an article of manufacture or for a masterbatch composition used in subsequent let-down processing.

Ionomers derived from parent acid copolymers having too low a melt flow rate (typically a rate below about 200 grams/10 minutes) may have an inadequate hot water self-dispersibility, while ionomers derived from parent acid copolymer having too high a melt flow rate (typically a rate above about 1000 grams/10 minutes) may impair the physical properties desired for some intended end uses.

In some embodiments, blends of two or more ethylene acid copolymers may be used, provided that the aggregate components and properties of the blend fall within the limits described above for the ethylene acid copolymers. For example, two ethylene methacrylic acid dipolymers may be used, such that the total weight % of methacrylic acid is about 18 to about 30 weight % of the total polymeric material and the melt flow rate of the blend before neutralization is about 200 to about 1000 grams/10 min.

Embodiments of the present composition permit the combined ionomer and nanoparticle filler to be mutually dispersed in hot water or other aqueous medium. In an embodiment, good dispersion of the nanoparticle filler in the ionomer is maintained after the composition is subsequently dried.

In various embodiments, the ionomer composition and the nanoparticle filler associated therewith combine the properties of being mutually self-dispersible in hot water or other aqueous medium along with being thermoplastic, allowing an ionomer composite to be fabricated into an article of manufacture or commerce of many types, e.g., by suitable melt processing, with a satisfactory degree of dispersion being maintained in the final article. In some embodiments, a sufficient dispersion and proper selection of the nanoparticle filler affords the ionomer composite a combination of good optical properties and mechanical properties that are enhanced over those of the unfilled ionomer.

Alternatively, the ionomer composite may be coated onto a substrate as either as an aqueous dispersion or in a molten state, allowing great flexibility in manufacture of coated articles. Beneficially, the nanofiller remains well dispersed after the initial formation of the material, e.g. by dilute solution processing, melt blending, or other suitable means. Adequate dispersion is further maintained after the material is formed into an article of manufacture, coated on a substrate, or let down in a host polymer.

The aqueous medium in which the ionomer composition and nanofiller are mutually dispersible may consist essentially of water. Alternatively, it may comprise water and one or more additional polar organic solvents. Without limitation, such solvents include lower alcohols having 1 to 5 carbon atoms, dimethylformamide (DMF), dimethylacetamide (DMAc), n-methylpyrrolidone (NMP), and formamide. The amount of such non-aqueous solvents included should be such that the ionomer composition and nanoparticle filler are mutually dispersible in the medium. In various non-limiting embodiments, the aqueous medium may comprise, or consist essentially of: water, water and up to 75 wt. % of one or more alcohols having 1 to 5 carbon atoms, water and up to 50 wt. % of isopropyl alcohol, or water and up to 50 wt. % of one or more of dimethylformamide (DMF), dimethylacetamide (DMAc), n-methylpyrrolidone (NMP), and formamide.

The ionomer composition used in the present composition of matter may also contain other additives known in the art. The particular additives selected may depend on the intended end use of the composite material, either to manufacture specific articles or as a masterbatch. The additives may include, but are not limited to, processing aids, flow enhancing additives, lubricants, pigments, dyes, flame retardants, impact modifiers, nucleating agents, anti-blocking agents such as silica, thermal stabilizers, UV absorbers, UV stabilizers, surfactants, chelating agents, and micron-scale reinforcing additives, such as glass fiber, fillers and the like. Notable additives include thermal stabilizers, UV absorbers, and hindered amine light stabilizers (HALS).

### Nanofillers

The present composition of matter includes a nanoscale filler material. As used herein, the term “nanoscale filler material” (or “nanofiller” or “nanoparticle filler”) refers to a material from which nanoparticles can be derived and dispersed in the present ionomer composition. The term “nanoparticle” refers to a particle having at least one dimension that is below about 100 nm. In different embodiments, the size of the nanoparticle in at least one dimension ranges from 0.9 nm to 100 nm, or about 0.9 to about 50 nm, or about 0.9 to about 50 nm, or about 0.9 to about 30 nm. It will be understood that the particles in an ensemble of like particles having a size distribution that is characterized by a median size below 100 nm, as measured in at least one dimension of the individual particles, may be denominated collectively as “nanoparticles.” Such a definition is consistent with other definitions found in the prior art. A wide variety of such nanoparticles are useful in the present composition of matter, ionomer composite, and multipolymer composite bodies constructed therewith.

Ideally, the presence of such nanoparticles enhances the properties of the polymer composition over what would be available without the inclusion. In various embodiments, inclusion of nanoscale filler material in the present composition of matter and articles made therewith imparts one or more desirable characteristics and/or combinations thereof, Such characteristics may include, without limitation and in any combination, low haze, high optical clarity, absence of undesirable coloration, high toughness, high scratch resistance, low creep, reduced coefficient of thermal expansion, and higher modulus, especially at elevated temperature. Ideally, some or all of these characteristics are provided while still maintaining properties conducive to manufacturing requirements. Embodiments of the present disclosure include ones useful in a variety of physical forms, including without limitation manufactured articles having desired, three-dimensional shapes, films, and coatings, that exhibit one or more of the foregoing or other desired physical properties. For example, in some implementations, the strength and creep resistance of an ionomer composite or a multipolymer composite are improved without imparting color or haze to a visually transparent composition.

Other representative embodiments of the present disclosure provide low scratch visibility and high scratch resistance, thereby causing them to retain a pleasing aesthetic appearance and to inhibit the formation of defected areas that may, in some instances, lead to sufficient stress concentration to cause cracking, crazing, or the like. Scratch resistance may be characterized using any suitable test, including those provided by ISO Method 1518-1 and ASTM Method D7027.

Importantly, the present nanoscale filler material and the ionomer composition are substantially free of organic onium substances, such as organoammonium, organophosphonium, and organosulfonium compounds used heretofore, for example, as dispersants, surfactants, or intercalating agents, e.g. for layered silicates. As used herein, the term “substantially free of onium substances” refers to material to which no such onium has been intentionally added or one in which the amount of onium present is not sufficient to provide measurable exfoliation of a layered filler material. Particles derived from the present nanoscale filler material also are hydrophilic.

In various embodiments, the present nanoscale filler material and the ionomer composition are also substantially free of silane coupling agents. In such materials, either no silane coupling agent is added in the preparation of the nanoscale filler material or used in subsequent processing to form the nanoparticles or the ionomer composite, or the amount present is not sufficient to provide good dispersion of the nanoscale filler in a polymer in which it would not ordinarily be well-dispersed.

Some particulate filler materials having average particle sizes below about 100 nm can be prepared by processes that entail use of grinding, crushing, milling, or other mechanical processes to make small particles from larger precursors. However, chemical synthesis, gas-phase synthesis, condensed phase synthesis, high speed deposition by ionized cluster beams, consolidation, deposition and sol-gel methods may also be used, and may be easier to use, for such purpose.

The nanoparticles used in the present composition may either be provided directly from the nanoscale filler material or be derived from larger particles in the nanoscale filler material during the manufacture of the composition or articles made therewith.

In some embodiments of the present disclosure, the nanoparticles dispersed in the ionomer composition are provided directly from a nanoscale filler material that comprises individual, discrete nanoparticles, which may be present in a suspension or dispersion in a liquid medium, or in a dried form. Such a material may be denominated a “nanoparticulate material.” Substantially all of an as-supplied nanoparticulate material used as the nanoscale filler material may be in the form of such nanoparticles. However, embodiments wherein some or all of the nanoscale filler material is in the form of particles that are larger than nanoparticles are also contemplated, if the processing of the filler provides suitable nanoparticles.

In various embodiments, the nanoscale filler material useful in the present ionomer composite may be a nanoparticulate material that is an ensemble of nanoparticles of SiO₂, TiO₂, ZnO, or ZrO₂, or carbon nanotubes. In other embodiments, the nanoscale filler material may comprise any hydrophilic metal oxide or metal oxide hydroxide. Nanoparticles useful in the present composition beneficially have a negative or neutral surface charge, so that they are sufficiently hydrophilic to be readily dispersed in water or other aqueous media.

Although not required, such nanoparticles are often prepared by condensation- or precipitation-based processes carried out in a gas or liquid environment, such that primary particles are produced that have an average particle dimension of 100 nm or less, as measured along the shortest axis.

In some instances, such particles are produced or provided in the form of a colloidal suspension in a liquid, e.g., water. An ensemble of any of the foregoing types of primary particles, whether in dry form or in a liquid dispersion or suspension, may be regarded as a nanoparticulate material as defined above. It is also to be understood that in some embodiments such a nanoparticulate material may include some fraction of particles that are apparently larger than the primary particle size.

In particular, it is contemplated that some or all of the as-supplied nanoscale filler material may be in the form of aggregated or agglomerated primary particles. In some cases, these particles still fall within the size range herein termed nanoparticle size, while others are larger. For example, it is known that the preparation or subsequent storage of many such materials that are initially formed as discrete nanoparticles may result in agglomerations or aggregations of multiple particles that are larger than nanoscale.

As used herein, the term “aggregated particle” refers to a structure comprising smaller particles that are relatively strongly associated by chemical or metallurgical bonding, such as by fusion, sintering, or the like. For example, such an aggregation may result from the techniques used to prepare particulate filler material. The term “agglomerated particle” refers to a structure in which smaller particles are relatively weakly bound together by physical forces. As known to one of ordinary skill, individual particles in an ensemble tend to agglomerate due to physical forces such as electrostatic and van der Waals interactions. The propensity for such agglomeration depends on the particle type and environmental conditions, but typically is heightened as the particle size decreases.

Ensembles containing agglomerated or aggregated particles can be processed in some instances to break some or all of the linkages by imparting sufficient energy, e.g. by shear, resulting in a change in the particle size distribution.

In some embodiments, a majority of, or even substantially all of, the as-supplied nanoscale filler material is in the form of larger agglomerated or aggregated particles. In an embodiment, the primary particle size may be 100 nm or smaller, whereas the agglomerates may be as large as 2 μm or more, as measured in at least one dimension. In another embodiment, the primary particle size may be 50 nm or smaller and the agglomerates as large as 10 μm or larger in at least one dimension. Such materials may be used if they can be processed to break up at least some of these particles into nanoparticles, even though some aggregated or agglomerated particles may persist after the nanoscale filler material is incorporated in the ionomer composition.

In some preferred embodiments of the present disclosure, any agglomerates present are readily de-agglomerated to provide nanoparticles in sufficient number and with a good dispersion, such that useful properties are attained in ionomer composites and multipolymer composites made with the nanoscale filler material.

In some embodiments, the nanoscale filler comprises particles produced and/or supplied in the form of a colloidal suspension of SiO₂, TiO₂, ZnO, or ZrO₂ in a liquid, e.g. water. Such particles may have a diameter characterized by d₅₀ of 10 to 100 nm or 10 to 75 nm. For example, suitable forms of colloidal silica are available from W. R. Grace under the tradename LUDOX®. In a further embodiment, the nanoparticles consist essentially of colloidal SiO₂ nanoparticles having negative or neutral surface charge.

In other embodiments, the nanoscale filler material may be a layered material comprised of an assemblage of crystallographic units that are joined in a generally sheet-like, two dimensional arrangement that may be of indefinite extent. Layered materials useful as nanoscale fillers in the present ionomer composition include layered silicates, graphene oxide, and reduced graphene and graphite oxides. Such materials are often supplied as particles typically of micron-size or larger that must be suitably processed to provide the nanoparticles used in the present ionomer composite. Such a process may be regarded as another form of de-agglomeration. Accordingly, the materials are deemed herein to qualify as nanoscale filler materials, and the nanoparticles derived from them are named by the material in its conventional form of supply.

Layered silicates, including without limitation natural clays and synthetic, clay-like materials, typically comprise repeating layers, each consisting essentially of a regular arrangement of particular sheets, at least one of which is formed in a generally planar arrangement by tetrahedrally coordinated, corner-sharing units. The successive layers in most, but not all, layered silicates are in registry. Most commonly, each layer also includes at least one sheet with octahedrally coordinated, edge-sharing units. Most layered silicates further include interlayer material separating the various layers. The interlayer material may include cations, hydrated cations, organic material, hydroxide octahedra, and/or hydroxide octahedral sheets, which act in part to provide charge neutrality by offsetting the net negative charge of most layers found in nearly all these materials. Layered silicate materials normally do not exhibit ideal, exact stoichiometric ratios of the constituent atoms and almost invariably contain substituent atoms.

One class of layered silicate materials is the phyllosilicate family, whose members contain continuous, two-dimensional tetrahedral sheets of indefinite extent with silicon and oxygen atoms in an approximate 2:5 ratio. The tetrahedra are linked by sharing three corners. The individual layers of phyllosilicate materials are typically 1-2 nm thick. Within the phyllosilicate classification are materials formed by the coherent stacking of layers having two tetrahedral sheets sandwiching an octahedral sheet. Other forms of phyllosilicates have layers with different numbers of tetrahedral and octahedral sheets.

A number of phyllosilicate materials are useful in the present ionomer composite. These include platy materials, in which a plurality of the foregoing layers are coherently stacked and bound in each particle of the as-supplied material, but are adapted to be exfoliated in the presence of an aqueous medium. “Exfoliation” refers to a form of de-agglomeration in which the initial particles are delaminated by separating adjacent layers. The products of exfoliation may be “platelets,” which are a single one of these layers, and/or “tactoids,” which are assemblages of a small number of the layers that remain bound coherently. There is no ordered spatial relationship between different exfoliated platelets and tactoids. While it is ideally desired that exfoliation be as complete as possible, it is found that exfoliation processes frequently produce only partial exfoliation, leaving a measurable population of platelets, tactoids, or larger particles. Both platelets and tactoids are “plates,” meaning they have a thickness that is substantially less than their dimensions in the two orthogonal directions. A material comprised predominantly of particles that are plates may be termed “platy.”

Without limitation, the nanoparticles included in the present ionomer composite may be derived from one or more clay or clay-like materials, such as one or more of smectite (e.g., aluminum silicate smectite), hectorite, montmorillonite (e.g., sodium montmorillonite, magnesium montmorillonite, or calcium montmorillonite), bentonite, beidelite, saponite, stevensite, sauconite, nontronite, illite, a mixtures of two or more thereof. Use of both naturally-occurring and synthetic forms of such materials is contemplated.

Other useful layered silicates include, without limitation, materials obtained from micas or clays or from a combination of micas and clays, or synthetic analogs thereof. Representative examples of sheet silicates include, without limitation, pyrophillite, talc, muscovite, phlogopite, lepidolithe, zinnwaldite, margarite, hydromuscovite, hydrophlogopite, sericite, nontronite, vermiculite, sudoite, pennine, klinochlor, kaolinite, dickite, nakrite, antigorite, halloysite, allophone, palygorskite, and synthetic forms thereof. An extensive discussion of the nomenclature, classification, and structure of clays and clay-like materials, along with representative examples useful as fillers in the present composition, is provided by Handbook of Clay Science, ed. F. Bergaya et al., London:Elsevier Ltd. (2006).

Several forms of layered synthetic clay-like material found useful in the present composition of matter are available commercially from Southern Clay Products division of Rockwood Additives, Gonzales, Tex., under the trade name Laponite®. Laponite® materials are said to be formed using hydrothermal synthesis processes and processed to yield a variety of grades, including those denominated by the manufacturer as Laponite®-RD, B, RDS, S482, XLG, XLS, D, DF, DS, S, JS, S482 and SL25. In some instances tetrasodium pyrophosphate (TSPP, Na₄P₂O₇) is used to condition the surface of Laponite® particles and other comparable platy materials, e.g. to alter their surface activity.

As respresented by the manufacturer, Laponite® refers generally to a material that is a synthetic, 2:1 layered hydrous magnesium lithium silicate related to the smectite-group mineral hectorite and has the approximate empirical chemical formula:

Na⁺_{0.7}[(Si₈Mg_{5.5}Li_{0.3})O₂₀(OH)₄]^{-0.7}.

In the fully exfoliated state, Laponite® nanoparticles typically have a generally disc-like or platelet-like morphology. The thickness is typically determined by the thickness of each 2:1 molecular sheet, which is approximately 0.9 nm. The particles are oval or circular in shape with an approximate diameter of 25 nm, though in some grades, the diameter approaches 100 nm.

Some of the Laponite® grades are fluorinated by at least partial substitution of fluorine atoms for hydroxyl groups, and thus may be regarded as synthetic fluorohectorites. In an embodiment, the extent of fluorine substitution is such that the fluoride anions comprise up to 1 wt. % of the filler material.

Various embodiments of the present disclosure comprise, or consist essentially of, one or more of the foregoing Laponite® or other like materials having the foregoing magnesium lithium silicate chemical formula, or such material with the optional fluorine substitution. It will be understood that the exact composition and particle morphology of synthetic materials produced by the hydrothermal processes typically used to form aluminosilicates and other like layered materials depend strongly on process parameters such as time, temperature, pressure, and pH. Consequently, there is ordinarily some variability in the precise composition and morphology that results, even within a single lot of material. Thus, it is to be understood that the formulas given herein for synthetic materials like Laponite® are approximate representations, as there is typically some variation in the precise atomic ratios of the constituents given. Notwithstanding this variability, the materials are to be understood as having the composition represented by the particular formulas set forth herein. Such variability is analgous to the compositional variability of naturally-occurring clays and other silicates derived from different deposits.

In an embodiment, Laponite® OG is incorporated in the present composition of matter, although other grades also may be employed. The material may be introduced either as dry powder or in an aqueous dispersion. During the different forms of processing disclosed herein, the layered structure is readily exfoliated.

Exfoliation of Laponite® materials may result in the concomitant formation of tactoids that may be up to 10, 20, or 40 nm thick. Useful composites are provided by ionomers filled with a dispersion of Laponite® particles that are fully exfoliated, or a mixture of even a large fraction of tactoids with some fully exfoliated platelets. In an embodiment, the exfoliation of the platy filler used in the present ionomer composite is sufficient to divide the nanoscale filler material such that 25% or 50% of 90% by weight is in the form of either fully exfoliated particles or tactoids less than 40 or 20 or 10 nm thick, or any combination thereof. See, e.g., U.S. Pat. No. 5,164,440 to Deguchi et al.

In some embodiments, a platy filler may be substantially exfoliated, meaning that at least 80 percent of the original background-subtracted X-ray diffraction peak intensity (height) due to the (001) basal plane spacing has been lost, as shown by a standard measurement. The term “(001) basal plane spacing” refers to the spacing between a layer of silicate atoms in one plane to the corresponding layer of silicate atoms in another plane, including any material present between layers. This can also be referred to as intergallery spacing, basal plane spacing, or d(001). Equivalently, the spacing can be regarded as being taken between the gravity centers of adjacent layers in the structure. See, e.g., US Published Patent Application US2010-0081749A1 to Mis et al. and col. 3, lines 7-9, of U.S. Pat. No. 5,164,440 to Deguchi et al. The value of the intergallery spacing is conveniently determined by wide-angle x-ray diffraction techniques, using Bragg's law to relate the spacing to an observed peak in the diffraction intensity.

Beneficially, Laponite® and other platy nanofillers used in the present composition attain excellent exfoliation and dispersion without the use of organic onium materials employed in previous ionomer composites to promote exfoliation. It has been found that the onium materials are prone to degrade under some processing and end-use conditions, thereby imparting an undesirable coloration to compositions in which they are used. Such coloration is regarded in the marketplace as especially deleterious in some three-dimensional articles of manufacture. Degradation of the onium material also can destabilize the composite and impair its mechanical, thermal, or other properties in some cases. As a result, employing onium-dispersed fillers have been found unsuitable.

Heretofore, it has been widely regarded as necessary to intercalate platy silicates such as Laponite® as a prelude to obtaining adequate exfoliation. By “intercalation” is meant the insertion of molecules in the interlayer space of the platy structure that cause the material to swell, as reflected in an appreciable increase in the intergallery spacing.

For example, certain polymers are known to intercalate platy aluminosilicate materials, causing the intergallery spacing to increase by as much as a factor of 2. Intercalation has also been accomplished using agents such as large organic alkylammonium ions, formed by quaternization or protonation of amines. These exchange with the cations often found in the interlayer space, thereby increasing the thickness of the interlayer. Other onium materials, such as alkylphosphonium and alkylsulfonium salts, have also been used similarly. However, even substantial intercalation does not guarantee any substantial degree of exfoliation. For example, the water-soluble polymer polyethylene oxide is known to intercalate nanoclays, but is not efficatious in causing exfoliation by itself or in combination with a second polymer, e.g. one added by melt-mixing. The presence of polyethylene oxide has been demonstrated to disrupt exfoliation if added to a composite of the present disclosure prepared with Laponite® particles and an ethylene copolymer.

By contrast, it has been found that in certain embodiments herein, dispersing suitable platy silicate materials in water or an aqueous medium is sufficient to produce substantial exfoliation without the further need for a prior intercalation. Exposure of the platy silicates to the water-dispersible ionomer composition used in the present ionomer composite does not cause significant intercalation, as signaled by at most modest increase of 50%, 35%, or 25% or less in the inergallery spacing seen after the platy filler is exposed to water and the present water-dispersible ionomer composition.

Although inclusion of high aspect-ratio platy layered silicate nanofillers can in principle enhance certain properties of polymers—e.g., mechanical, electrical, thermal, creep, tribological, adhesion, and barrier properties—they are generally regarded as difficult to disperse and especially difficult to exfoliate, because their charged inorganic surfaces are more compatible with each other than polymer matrices. Properly configured fillers that are well-dispersed and exfoliated have been found to offer mechanical property enhancements without loss of transparency. Embodiments featuring this combination are beneficial for ethylene copolymers used for clear packaging and molding applications (e.g., perfume bottle caps), protective glass interlayers (e.g., building and car windows), and encapsulants for photovoltaic devices.

As known to a person skilled in the art of silicate materials, cation exchange capacity (or CEC) refers to the surface charge of a phyllosilicate that reflects the negative imbalance of charges originating from the silicate layers of the mineral. The value of CEC represents the number of cations that a given material is capable of holding in its intersurface layers, and is typically measured in milliequivalents (meq) per 100 g. In an embodiment, the phyllosilicate used in the present ionomer composite has a CEC of less than 100, or 80, or 65 meq/100 g. Nanofillers having such values of CEC are typically hydrophilic to an extent that renders them easily dispersible in water or other aqueous medium.

Other platy silicates useful in the present ionomer composite incorporate naturally-occurring montmorillonite (MMT) and vermiculite materials. For example, montmorillonite clay platelets may have thicknesses on the order of 1 nm and lateral dimensions ranging from 100 to over 200 nm.

Certain phyllosilicates having a character that is fibrous instead of platy may also be used. Such materials can, under suitable treatment, be deagglomerated to form nanoparticles that have acicular, lath-like, or ribbon-like form, wherein a thickness or diameter is less than 100 nm, and may be as small as 1-2 nm. For example, forms of sepiolite are self-dispersing in the presence of water to form ribbon-like particles. In an embodiment, dispersed sepiolite nanoparticles have a ribbon-like form, with a thickness of about 1 nm, a width of about 15 nm, and a length that may be up to several μm. One useful form of sepiolite is available from Tolsa Industrial Products under the trade name Pangel™.

In various possible embodiments, the nanoscale filler material of the present composition comprises nanoparticles of at least one of a natural or synthetic layered silicate; graphene oxide; reduced graphite or graphene oxide; SiO₂, TiO₂, ZnO, or ZrO₂ nanoparticles, or carbon nanotubes. Also provided are embodiments that employ a plurality of such nanoscale filler materials, which in some cases contribute to improvement of multiple desirable properties.

The carbon nanofibers used here may be single-walled nanotubes (SWNT) or multi-walled nanotubes (MWNT). Suitable carbon nanofibers are commercially available, such as those produced by Applied Sciences, Inc. (Cedarville, Ohio) under the tradename Pyrograf™.

Nanoparticles are included in the present composition of matter in varying amounts, depending on the intended end use and properties desired. In various embodiments, the content of nanoparticles may lie in a range from a lower limit of 0.01, 0.1, 0.5, 1, 5, 10, or 15 wt. % to an upper limit of 15, 20, 30, 50, 70, or 80 wt. %, or a range defined by any combination of these lower and upper limits, wherein the weight percentages are based on the entire composition of matter. Ordinarily, higher levels of nanoparticle loading are desired for a masterbatch appointed for let-down in a host polymer, to account for dilution in the let-down polymer. Compositions intended to be formed directly into finished articles of manufacture typically employ lower loading.

In certain embodiments, particularly ones in which the composition of matter is appointed for end use in an article of manufacture or commerce, the nanoparticles may comprise 0.1 to 25 wt. %, 1 to 20 wt. %, or 3 to 15 wt. %, based on the total composition. Alternative embodiments, particularly ones in which the composition of matter is appointed as a masterbatch to be let down into another polymer, may comprise 15 to 80 wt. %, 20 to 60 wt. %, 20 to 50 wt. %, or 25 to 35 wt. % of nanoparticles, based on the total composition.

Nanoparticles of the filler material may have a variety of sizes and shapes, encompassing forms such as irregular shapes as well as high aspect ratio particles that include rod-like, needle-like, ribbon-like, platy, and layered nanofillers. Generally stated, “aspect ratio” refers to the ratio of the sizes of the particles in an ensemble in their longest to their intermediate or shortest average dimension. In different embodiments, the aspect ratio of the present nanoparticles may range from 30 to 150 or 25 to 300, or even higher. Such an aspect ratio may pertain, for example, to ensembles of either rod-like or platy primary particles.

A number of techniques are known in the art for characterizing the size of small particles by either direct or indirect measurements. It is known that different techniques give different size results for the same particles, especially ones that have non-spherical or irregular shape or a multi-modal distribution. For example, a widely-used indirect method is the Brunauer-Emmett-Teller (BET) technique, which provides a determination of the aggregate effective surface area of a known mass of particles, based on a measurement of the amount of gas that can be adsorbed on the surface of the ensemble of particles. The amount of gas is used to calculate a specific surface area of the ensemble (area per unit mass), by assuming the ensemble to consist of monodisperse, fully dense spheres.

At the other extreme, direct imaging, e.g. using scanning or transmission electron microscopy, permits individual particles to be imaged and sized directly. Image analysis techniques can be applied to electron micrographs to quantify size distributions and shape characteristics, such as the departure from spherality. However, skilled interpretation may be needed to identify other crucial features, such as porosity, and to ascertain whether the object being visualized is a primary particle or an association of multiple primary particles, e.g. particles that have agglomerated or are joined more rigidly.

Radiation scattering techniques, including small-angle x-ray and neutron scattering and static or dynamic light scattering also can be used to determine ensemble averages and size distributions although broad or multimodal distributions and irregular shaped particles or distributions of shape complicate interpretation of the scattering data.

Various statistical characterizations can be derived from particle distribution data obtained using either dynamic or static light scattering. The d₅₀ or median particle size by volume is commonly used to represent the approximate particle size. Other common statistically derived measures of particle size include d₁₀ and d₉₀. It is to be understood that 10 vol. % and 90 vol. % of the particles in the ensemble have a size less than d₁₀ and d₉₀, respectively. These values, taken either singly or in combination with the d₅₀ values, can provide additional characterization of a particle distribution, which is especially useful for a distribution that is not symmetrical, or is multimodal, or complex.

Particles used in some embodiments of the present disclosure may have irregular shapes, such as those that arise from crushing or milling processes. The particles may also have round or faceted shapes and may be substantially fully dense or have some degree of porosity. Faceted shapes may include needle-like sharp points or multiple, substantially planar faces. The particulate fillers may be composed of individual primary particles. Alternatively, some or all of the particulate filler material may be in the form of an aggregation or agglomeration of such primary particles. In some embodiments, partially agglomerated particles have an overall shape which can be irregular or fractal in character. In some instances, the particles exhibit substantial internal porosity, either by virtue of the partially agglomerated state or as a consequence of the preparation procedure used.

### Host Polymers

A further aspect of the present disclosure provides a multipolymer composite that comprises the foregoing ionomer-based, nanofilled composition of matter along with another polymer termed a host polymer. Such a multipolymer composite may be formed by any suitable means. In an embodiment, the multipolymer composite is formed by a let-down operation, in which the filled ionomer composition is combined with the host polymer by any suitable form of melt processing, such as melt blending or coextrusion. Such an operation is facilitated by employing compatible polymers as the carrier and host polymers. The term “compatible polymers” refers to a combination of a first polymer and a second polymer (here the carrier and host polymers, respectively) such that the first polymer is either: (i) substantially mutually miscible or soluble in the second polymer or (ii) dispersible in the second polymer such that in the combination, one of the individual polymers is separately detectable only in localized domains or particles in the second polymer that have an average particle or domain size of at most 1, 0.5, or 0.1 μm.

In a further embodiment, the carrier and host polymers are both compatible and melt-miscible. “Melt-miscible polymers” are ones that in at least the molten state are fully and intimately mixed at a molecular level and do not exhibit regions in which one of the constituent polymers is separately detectable. Melt-miscible polymers further include polymers that remain intimately mixed, without separately detectable regions, even after they solidify from the melt.

For example, in certain embodiments herein, ethylene copolymers differing in their content of acrylic or methacrylic acid by as much as 5%, 7%, or 10% by weight are generally found to be miscible. Ethylene copolymers differing in their content of acrylic or methacrylic acid by more than 10% may still be compatible, even if not miscible. Embodiments useful in the practice of the present disclosure include ones that comprise a water-dispersible ionomer (in which nanofiller is appointed to be dispersed) and a host polymer compatible therewith.

Host, let-down polymers usefully combined with the present masterbatch in practicing the present disclosure include, without limitation, ethylene methyl acrylate copolymer (E/MA); ethylene methacrylic acid copolymer (E/MAA); ethylene acrylic acid copolymer (E/AA); and an ionomer from E/MAA or E/AA. Optionally, the let-down E/MA, E/MAA, E/AA, or ionomer further comprises some portion of one or more termonomers, which include, without limitation, ethyl acrylate, methyl acrylate, iso- and n-butyl acrylate, methyl methacrylate, maleic anhydride, methyl hydrogenate maleate, and ethyl hydrogenate maleate. In an embodiment, the acid level of any of the E/MA-, E/MAA-, or E/AA-base copolymers differs from that of the masterbatch ionomer by no more than 8 wt. %, 5 wt. %, or 2 wt. %. In various embodiments, the acid of the E/MA-, E/MAA-, or E/AA-base copolymer may be one or more of acrylic acid, methacrylic acid, maleic anyhydride, methyl hydrogenate maleate, or ethyl hydrogen maleate.

Further, the host polymer may comprise, or consist essentially of, a host ionomer wherein derived from a host acid copolymer comprising copolymerized units of an α-olefin having 2 to 10 carbons and units of an α,β-ethylenically unsaturated carboxylic acid having 3 to 8 carbons, and wherein at least a portion of the unsaturated carboxylic acid groups are neutralized by cations to form carboxylate salts. Although the neutralizing cations preferably are monovalent alkali metal cations, divalent alkaline earth metal (Mg²⁺, Ca²⁺, Sr²⁺, or Ba²⁺) cations, or monovalent or divalent transition metal cations, embodiments comprising other monovalent, divalent, or trivalent cations are also contemplated. In certain embodiments, ionomers useful as the host polymer have a melt flow rate (MFR) after neutralization of at least 0.5 g/10 min, such as about 0.5 to about 20 g/10 min, or about 1 to about 10 g/10 min, or about 1 to about 5 g/10 min after neutralization. In an embodiment, the ionomer composition comprises at least 11 weight % methacrylic acid salt and has a MFR of at least 1 g/10 min.

In another embodiment, the let-down polymer may be a polyamide or a polyolefin, including without limitation ethylene, propylene, butylene, and copolymers thereof.

Of course, the present masterbatch can also be let down into substantially the same ionomer as used to prepare the masterbatch.

### Alloying Polymer

A further aspect of the present disclosure provides an alloyed multipolymer composite, wherein the foregoing multipolymer composite is further combined with an additional polymer that differs from the host polymer and is termed an “alloying polymer.” Such an alloyed multipolymer composite may be formed by any suitable means.

In an embodiment, the alloyed multipolymer composite is formed by a let-down operation, in which the filled ionomer composition is combined with the host polymer by any suitable form of melt processing, such as melt blending or coextrusion, and the resulting composition is further combined with a second polymer by any suitable form of melt processing, such as melt blending or coextrusion. The first let-down operation is facilitated by employing compatible polymers as the carrier and host polymers. The combination with the alloying polymer is also facilitated by employing compatible polymers as both the host and alloying polymers.

Alloying polymers usefully combined with the multipolymer composite in practicing the present disclosure include, without limitation, polyamides, polyesters, and polyacetals. In various embodiments, the alloying polymers are polyamides, such as nylon 6 and nylon 66. In an embodiment, the host polymer used in the alloyed multipolymer composite is one or more of ethylene methacrylic acid copolymer (E/MAA); ethylene acrylic acid copolymer (E/AA); and ionomers therefrom, that optionally include one or more of the termonomers methyl hydrogenate maleate, ethyl hydrogenate maleate, and maleic anhydride.

### Processing

The preparation of the present composition of matter and masterbatch can be carried out in any suitable manner.

One implementation provides for dilute solution processing, in which the requisite ionomer and the filler are combined as a relatively dilute solution or dispersion in an actual aqueous medium. In an embodiment, this preparation is formed in the liquid medium and without the need for high-shear mixing. Thereafter, the liquid is removed by evaporation, preferably under vacuum and heat, and dried, thereby providing a dry substance in the form of powder, flakes, or film.

Another implementation employs melt-blending or melt-compounding equipment, in which the filler is added to molten base ionomer either as a powder or as an aqueous solution or slurry. In one variant, water or other aqueous medium is injected along with the filler, to promote better dispersion. The filled output resin then is typically dried and formed into powder, granules, or pellets suitable for further processing, either into finished articles or as a masterbatch for further processing.

Melt blending can be accomplished with batch mixers (e.g. mixers such as the HAAKE™ Rheomix from Thomas Scientific, the Brabender® mixer, the Brabender® mixer, the Banbury® mixer from Farrel Corporation, the Xplore® microcompounder from DSM Research, and comparable equipment from other manufacturers, or with continuous compounding systems, which may employ extruders, planetary gear mixers, or other mixing configurations. Suitable continuous process equipment includes co-rotating twin screw extruders, counter-rotating twin screw extruders, multi-screw extruders, single screw extruders, co-kneaders (reciprocating single screw extruders), and other equipment designed to process viscous materials.

The present multipolymer and alloyed multipolymer composites are typically prepared by melt blending or melt compounding in one step at the desired filler concentration, or sequentially by first making a concentrate masterbatch (prepared by any of the foregoing or other methods) with the one or more desired host and, optionally, an alloying polymer. The masterbatch may then be let down into host or alloying polymers in a second melt blending step. The sequential steps can be carried out either with similar processing equipment for each or with different equipment for the different steps. In other alternatives, the manufacturing may be done in a continuous, in-line process wherein the masterbatch is prepared and then delivered directly to be let down into a host polymer by melt compounding.

In an embodiment, any of the present ionomer composite, masterbatch thereof, multipolymer composite, and alloyed multipolymer composite are substantially free of water. For example, the final product materials may be dried to reduce the water content to that of typical commercial resin products, which may be less than 0.1% or 0.05% by weight. In other embodiments, the water level is less than 5%, 2%, 1%, or 0.5% by weight.

### EXAMPLES

The operation and effects of certain embodiments of the present invention may be more fully appreciated from a series of examples, as described below. The embodiments on which these examples are based are representative only, and the selection of those embodiments to illustrate aspects of the invention does not indicate that materials, components, reactants, conditions, techniques and/or configurations not described in the examples are not suitable for use herein, or that subject matter not described in the examples is excluded from the scope of the appended claims and equivalents thereof. The significance of the examples is better understood by comparing the results obtained therefrom with the results obtained from certain trial runs that are designed to serve as comparative examples, which provide a basis for such comparison since they either do not contain nanoparticulate filler material and ionomers that are mutually dispersible in an aqueous medium or are processed by different methods.

### Materials

Materials used in carrying out the examples and comparative examples set forth below include the following:

### Ionomers:

Ionomer ION-A—an ethylene copolymer with about 19 wt. % methacrylic acid that is 50% neutralized by K⁺ cations and has a melt flow rate (MFR) of about 330 g/10 min before neutralization and about 4.5 g/10 min after neutralization, as determined in accordance with ASTM Standard Method D1238 at 190° C. and 2.16 kg;
Ionomer ION-B—an ethylene copolymer with about 19 wt. % methacrylic acid that is 60% neutralized by Na⁺ cations and has a melt flow rate (MFR) of about 330 g/10 min before neutralization and about 1.2 g/10 min after neutralization;
Ionomer ION-C—an ethylene copolymer with about 19 wt. % methacrylic acid that is about 40% neutralized by Na⁺ cations and has a melt flow rate (MFR) of 4.4 g/10 min;
Ionomer ION-D—an ethylene copolymer with about 19 wt. % methacrylic acid that is about 45% neutralized by Zn²⁺ cations and has a melt flow rate (MFR) of 4.1 g/10 min.
ION-E: an ethylene copolymer with about 19 wt. % methacrylic acid that is partly neutralized by Na⁺ cations and has a melt flow rate (MFR) of 4.5 g/10 min;
ION-F: an ethylene copolymer with about 15 wt. % methacrylic acid that is 58% neutralized by Zn²⁺ cations and has a melt flow rate (MFR) of 0.7 g/10 min;
ION-G: an ethylene copolymer with about 21 wt. % methacrylic acid that is 28% neutralized by Na⁺ cations and has a melt flow rate (MFR) of 2 g/10 min after neutralization;
ION-H: an ethylene copolymer with about 15 wt. % methacrylic acid that is 23% neutralized by Zn⁺⁺ cations and has a melt flow rate (MFR) of 5.5 g/10 min;
ION-J: an aqueous dispersion of about 22 wt. % of an ethylene copolymer with about 18 wt. % acrylic acid that has is about 80% neutralized by ammonia and has a melt flow rate (MFR) of 60 g/10 min;

### Other Polymers:

Nylon 66 polyamide, available from DuPont Corporation, Wilmington, Del. under the tradename Zytel® 101;
E/MA-1: an ethylene copolymer with about 20 wt. % methyl acrylate;
E/MAA-2: an ethylene copolymer with about 15 wt. % methacrylic acid that is not neutralized and has a melt flow rate (MFR) of 60 g/10 min;—and
Linear Low Density Polyethylene (LLDPE, Petrothene® NA206 supplied by LyondellBasell Industries).

### Nanofillers:

Laponite® OG (Southern Clay Products division of Rockwood Additives, Gonzales, Tex.), represented by the manufacturer as a synthetic sodium magnesium silicate composed of platelets about 83 nm long and 1 nm thick having a cation exchange capacity (CEC) of about 50-60 meq/100 g;
Laponite® RD, represented by the manufacturer as a synthetic sodium magnesium silicate composed of platelets about 25 nm long and 1 nm thick and having a cation exchange capacity (CEC) of about 55 meq/100 g;
Laponite® B, represented by the manufacturer as a synthetic sodium magnesium fluorosilicate composed of platelets about 55 nm long and 1 nm thick and having a cation exchange capacity (CEC) of about 100 meq/100 g;
Laponite® JS, represented by the manufacturer as a synthetic sodium magnesium fluorosilicate composed of platelets about 40 nm long and 1 nm thick that has been treated with tetrasodium pyrophosphate and has a cation exchange capacity (CEC) of about 90-100 meq/100 g;
Ludox® TM-40 (manufactured by W. R. Grace and Co. and supplied by Sigma-Aldrich) is an anionic colloidal silica dispersion containing approximately 22-nm diameter silica particles with sodium cations, at 40 wt. % in H₂O with a pH of 9;
Ludox® TMA (manufactured by W. R. Grace and Co. and supplied by Sigma-Aldrich) is a deionized colloidal silica dispersion containing approximately 22-nm diameter silica particles at 34 wt. % in H₂O with a pH of 4-7;
Ludox® CL (manufactured by W. R. Grace and Co. and supplied by Sigma-Aldrich) is a cationic colloidal silica dispersion containing approximately 22-nm diameter silica particles that have been surface-treated with alumina, at 30 wt. % in H₂O with a pH of 4.5;
Cloisite® Na⁺ is an unmodified, naturally occurring montmorillonite clay (Southern Clay Products division of Rockwood Additives, Gonzales, Tex.) having a cation exchange capacity (CEC) of about 92 meq/100 g;
Pangel® S9 sepiolite (available from Tolsa Group, Campezo St. 1, Building 4, Madrid 28022, Spain) having a cation exchange capacity (CEC) of about 3-15 meq/100 g;
Graphene oxide, 0.5 wt. % dispersion in water (Angstron Materials Inc., Dayton, Ohio, catalog no. N002-PS); and
Microlite® 923 vermiculite, supplied by W.R. Grace in an aqueous slurry having a cation exchange capacity (CEC) of about 100-150 meq/100 g.

### Example A

### Preparation of Ionomer Composites Containing Layered Silicate Nanofillers by Dilute Solution Processing

A series of ionomer composites containing certain partially neutralized ionomers and synthetic hectorite platy nanofiller particles was prepared.

Each of the exemplary compositions described in Table I was prepared in a round-bottom flask equipped with a mechanical stirrer, heater, and temperature controller. Ionomer ION-B (in the form of small pellets) and deionized water at room temperature were added in order to the round-bottom flask in quantities shown in Table I, with the stirrer operated at a good mixing rate, but not so fast as to cause splashing. The flasks were stirred at room temperature for 5 min., then heated to 80° C. Then the temperature controller was reset to 90° C. After the flask reached 90° C., it was stirred for 20 min. to fully dissolve the polymer. The heater and temperature controller were then removed, with the flask being stirred until it cooled to room temperature. Then the requisite amount of Laponite® OG synthetic hectorite filler was added to the polymer solution with very rapid mechanical stirring and a vortex that wetted out the powder before it formed clumps. The mixture was stirred for 30 min to thoroughly dissolve the Laponite® nanoparticles.

Each solution was then dried to afford a solid mixture for analysis of properties and for further use. Drying was accomplished by attaching the flask to a rotary evaporator, to which a vacuum was applied, immersing the flask in a water bath at 65° C., and gradually raising the bath to a maximum 85° C. as the solvent was removed. The evaporation process was performed gradually over 1-2 days and with slowly increasing temperature to avoid any bumping problem associated with the water. The solid product removed from the flask was further dried for about 16 to 64 hours in a 50° C. oven, with applied house vacuum and nitrogen bleed, to produce a film that was scraped out of the flask in the form of randomly-shaped pieces. The same water processing procedure was also used to prepare ionomer samples (Comparative Example CE2) using the same starting ionomer pellets, but without any nanofiller.

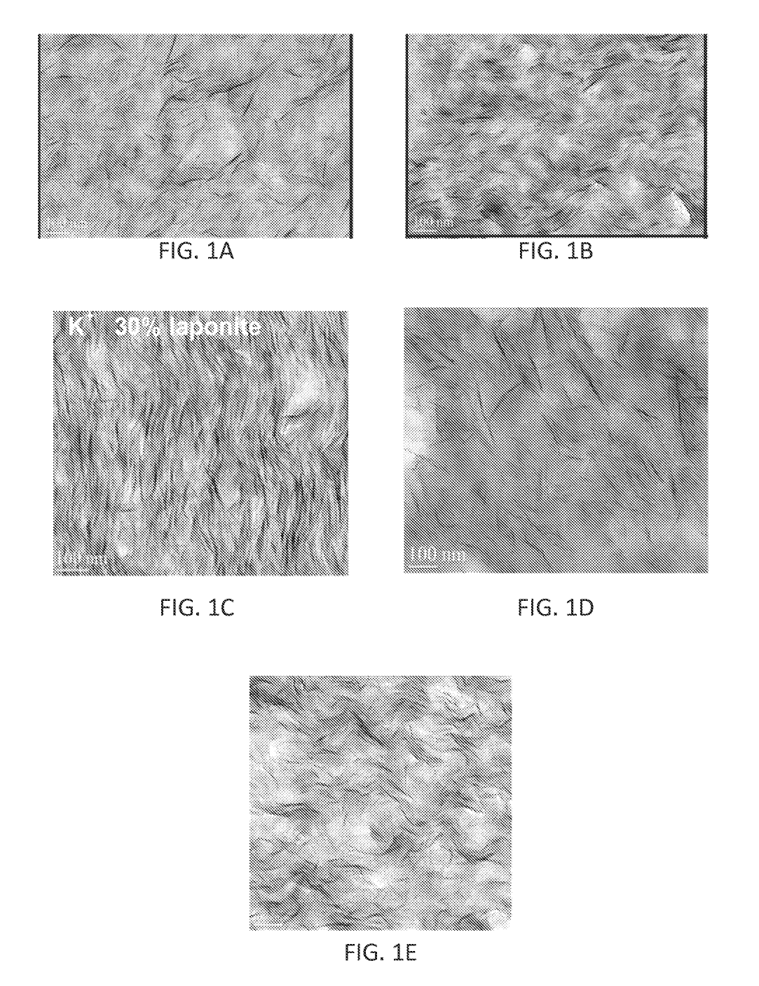

Transmission electron microscopy (TEM) studies were carried out to characterize the dispersion and exfoliation of the Laponite® OG particles in the ionomers, yielding images that are shown in FIGS. 1A to 1E, which correspond to Examples 1, 2, 3, 8, and 9, respectively. The degree of dispersion of these and other images provided herein was visually rated on a scale of excellent-good-fair-poor.

Wide-angle X-ray analysis (WAXS) using Cu Kα radiation was used to determine the intergallery spacing. The data set forth in Table I surprisingly show that the intergallery spacing is only slightly increased by the addition of the ionomer, indicating that it does not intercalate the Laponite® OG material to a significant degree. In contrast, prior art processes have typically relied on cationic intercalating agents such as quaternary ammonium and other onium or suitable polymers to effect intercalation and, if possible to thereby enhance exfoliation and good dispersion. Such intercalation is indicated by a much larger increase in intergallery spacing, often to 1.8-2.0 nm or more. As received, Laponite® OG has an intergallery spacing of 1.16 nm.

TABLE I
Laponite ® OG/Ionomer Composites

| Example No. | CE2 | 1 | 2 | 3 | 4 | 5 | 6 | 8 | 9 |
|---|---|---|---|---|---|---|---|---|---|
| Deionized water, g | 165.0 | 165.0 | 330.0 | 165.0 | 165.0 | 165.0 | 165.0 | 165.0 | 330.0 |
| ION-A, g | 49.05 | 16.35 | 14.7 | 11.55 | 16.35 | 49.05 | 22.05 | — | — |
| ION-B, g | — | — | — | — | — | — | — | 16.35 | 14.7 |
| Laponite ® OG, g | — | 1.65 | 3.3 | 4.95 | 1.65 | 4.95 | 4.95 | 1.65 | 3.3 |
| Calculated total wt after drying, g | 49.0 | 18.0 | 18.0 | 16.5 | 18.0 | 54.0 | 27.0 | 18.0 | 18.0 |
| Calculated wt. % of Laponite ® in dried solids | 0% | 9.2% | 18.3% | 30.0% | 9.2% | 9.2% | 18.3% | 9.2% | 18.3% |
| Intergallery d-spacing (WAXS), nm | — | — | 1.45 | — | — | — | — | 1.48 | 1.48 |
| Exfoliation, dispersion quality (TEM) | — | excellent | excellent | excellent | excellent | good | excellent | excellent | excellent |

### Example B

### Optical Properties of Ionomer Composites

### Haze, Transmittance and Yellowness Index

Haze, Transmittance, and Yellowness Index were determined for 125 μm thick ionomer composite films made by hot-pressing compositions of selected examples from Table I. Film samples were prepared by pressing pieces of dried material inside a 5 cm square cutout in a 125 μm thick aluminum foil sheet. The polymer material was sandwiched by two polyimide sheets and two thicker aluminum sheets. This mold sandwich was preheated to 150° C. in the press without applied pressure and then pressed under a 10-ton force for 3 min. The sandwich was then removed and cooled, and the polymer film removed for further study. If bubbles were observed in any film, it was pressed again under the same conditions to remove the bubbles.

The same technique was also used to prepare comparative example samples without nanofillers. Film samples were made using pellets of the ionomer ION-A feedstock (designated as Comparative Example CE1) and from water-processed ionomer ION-A (Comparative Example CE2).

Ultraviolet/visible wavelength spectra of the films were measured in the 380-780 nm wavelength range using a Varian Cary 5000 uv/vis/nir spectrophotometer equipped with a Varian DRA-2500 integrating sphere. Cary WinUV Color application software was used to quantify the colorimetric properties. In particular, transmittance and haze were determined in accordance with ASTM Standard Method D1003, while Yellowness Index (YI) was calculated in two ways, in accordance with ASTM Standard Methods E313 and D1925, respectively, and in both using Illuminant CIE C. The resulting data are set forth in Table II, which also includes data for samples of Comparative Examples CE1 and CE2.

Film samples with up to 18 wt. % filler content are seen to exhibit optical properties that do not differ substantially from those of Comparative Examples CE1 and CE2, which do not contain a nanofiller. At 30 wt. % filler, the haze and yellowness differ more measurably from the unfilled ionomer samples, but the change is still not large.

The data of Table II thus demonstrate excellent retention of good optical properties, including a minimized haze, in the present ionomer composite. In contrast, conventional composites show appreciable light scattering and thus have markedly degraded haze because of the refractive index and size of their filler particles. Composites that include nanofillers that are poorly dispersed, poorly exfoliated, or significantly agglomerated, also tend to exhibit degraded haze.

TABLE II
Optical Properties of Ionomer Composites

| | | | Total | Diffuse | | |
|---|---|---|---|---|---|---|
| | | | luminous | luminous | Yellow- | Yellow- |
| | | | trans- | trans- | ness | ness |
| | | Haze | mittance | mittance | Index, | Index, |
| Example | | ASTM | ASTM | ASTM | ASTM | ASTM |
| No. | Material | D1003 | D1003 | D1003 | E313 | D1925 |
| CE1 | ION-A feedstock | 1.52% | 0.919 | 0.014 | 2.03 | 1.91 |
| CE2 | Water-processed ION-A | 0.93% | 0.922 | 0.009 | 1.97 | 1.83 |
| 4 | ION-A + 9.2% Laponite ® OG | 1.17% | 0.920 | 0.011 | 2.07 | 1.97 |
| 6 | ION-A + 18.3% Laponite ® OG | 1.95% | 0.912 | 0.018 | 2.35 | 2.31 |
| 3 | ION-A + 30.0% Laponite ® OG | 4.76% | 0.905 | 0.043 | 2.59 | 2.62 |
| 8 | ION-B + 9.2% Laponite ® OG | 3.96% | 0.901 | 0.036 | 2.38 | 2.37 |
| 9 | ION-B + 18.3% Laponite ® OG | 14.68% | 0.868 | 0.127 | 3.37 | 3.70 |

### Example C

### Mechanical Properties of Ionomer Composites: Stress-Strain Properties

Stress-strain mechanical data were obtained for films of the present ionomer composite. For comparison, data were also obtained for samples of the unfilled ionomers of Comparative Examples CE1 and CE2.

Using hot-pressing techniques comparable to those described in Example B, samples were made in the form of 4 cm-diameter, 125 μm-thick disks. A 0.2 g portion of each sample was sandwiched between polyimide sheets and aluminum sheets and preheated at 135° C. for 45 sec., with the press platens just touching sandwich, without applying pressure to the mold. Then the sandwich was pressed for 40 sec. under 10 tons of force, with a brief release at 5 tons. Thereafter, the sandwich was removed and cooled. The films were aged for at least a week at room temperature, then equilibrated at 50% relative humidity for at least a day before testing. Small dogbone specimens were cut from the film disks, typically yielding 5 to 6 specimens per example. The films were tested on an Instron machine at 75° C. and 50% relative humidity, according to ASTM D1708, “Standard Test Method for Tensile Properties of Plastics by Use of Microtensile Specimens.” The average results and standard deviations for Young's Modulus (E), Elongation at Break, and Stress at Yield are reported in Table III. These data show that the incorporation of Laponite® nanoparticles substantially elevates the Young's modulus of the water-dispersible ionomer, 2.5-fold at 9 wt. % and 4-fold at 18 wt. %. Stress at yield was also improved. Compared with Example 4, which had excellent dispersion of the Laponite® OG nanofiller, Example 5 had less well dispersed nanofilter, but its mechanical properties were little reduced except for a large loss in the elongation at break.

TABLE III
Stress-Strain Mechanical Properties of Ionomer Composites

| | | | Young's | Elongation | Stress |
|---|---|---|---|---|---|
| | | Filler | Modulus | @ Break | @ Yield |
| Example | | dispersion | (MPa) | (%) | (MPa) |
| CE1 | ION-A pellets | — | 230 ± 20 | 260 ± 30 | 14 ± 1 |
| CE2 | Water-processed ION-A | — | 230 ± 10 | 220 ± 70 | 13 ± 1 |
| 4 | ION-A + 9.2% Laponite ® OG | excellent | 540 ± 90 | 110 ± 80 | 18 ± 1 |
| 5 | ION-A + 9.2% Laponite ® OG | good | 589 ± 54 | 7 ± 1 | 17 ± 2 |
| 6 | ION-A + 18.3% Laponite ® OG | excellent | 900 ± 130 | 11 ± 10 | 21 ± 2 |

### Example D

### Physical Properties of Ionomer Composites

### Coefficient of Thermal Expansion (CTE)

Further film samples were prepared as 125 μm thick, 4 cm diameter disks using the hot-pressing method employed for Examples B and C. The pressed films were dried at 40° C. overnight, then transferred to a dry nitrogen enclosure until tested. For the test they were placed in a TA Instruments TMA 2940 Thermomechanical Analyzer (TMA), equilibrated at −50° C., then ramped at 5° C./min to 80° C. The expansion of the films was measured over specified temperature ranges to yield a Coefficient of Thermal Expansion (CTE). The results in Table IV show that incorporation of Laponite® OG nanoparticles reduced the CTE of the present ionomer composite by up to 50%.

TABLE IV
Coefficient of Thermal Expansion of Ionomer Composites

| | | | CTE | CTE |
|---|---|---|---|---|
| Example | | Filler | −40° to 40° C. | 0° to 65° C. |
| Number | Material | dispersion | (μm/m-K) | (μm/m-K) |
| CE1 | ION-A pellets | — | 125 | 272 |
| CE2 | Water-processed ION-A | — | 125 | 343 |
| 4 | ION-A + 9.2% Laponite ® OG | excellent | 87 | 255 |
| 5 | ION-A + 9.2% Laponite ® OG | good | 114 | 258 |
| 6 | ION-A + 18.3% Laponite ® OG | excellent | 65 | 165 |

### Example E

### Mechanical Properties of Ionomer Composites

### Dynamic Mechanical Analysis

Samples of the present ionomer composites suitable for dynamic mechanical analysis (DMA) were prepared using a modification of the melt-pressing technique employed for Examples B and C. The amount of starting material was increased to about 0.5 g and additional layers of aluminum foil were stacked in the mold sandwich to permit sample films to be formed as disks of film 0.5-0.6 mm thick and about 2.5 cm in diameter. After pressing, the films were dried at 40° C. overnight, then transferred to a dry nitrogen enclosure until tested. The films were cut into narrow test strips, about 10 mm long and 6 mm wide. They were placed between the grips of a small double razor jig in a TA Instruments Q800 Dynamic Mechanical Analyzer and tested at a frequency of 1 Hz between −140 and +100° C., at a scan rate of 2° C./min, yielding the storage and loss moduli shown Table V.

Comparison of DMA data for samples made with the ionomer composite compositions of Examples 4-6 with data for unfilled ionomer compositions CE1 and CE2 shows very significant and desirable increases in both storage and loss moduli at room temperature. The effect is even more pronounced above 95° C., which is above the peak melting point of the polymer, so that there is little crystallinity to maintain the sample's integrity.

TABLE V
Dynamic Mechanical Analysis of Ionomer Composites

| | | | Loss | Loss | Storage | Storage |
|---|---|---|---|---|---|---|
| | | | Modulus | Modulus | Modulus | Modulus |
| | | Filler | @ 25° C. | @ 95° C. | @ 25° C. | @ 95° C. |
| Example | | dispersion | (MPa) | (MPa) | (MPa) | (MPa) |
| CE1 | ION-A pellets | — | 13.81 | 0.77 | 324 | 1.44 |
| CE2 | Water-processed ION-A | — | 33.2 | 0.81 | 652 | 1.43 |
| 4 | ION-A + 9.2% Laponite ® OG | excellent | 41.67 | 3.46 | 989 | 7.71 |
| 5 | ION-A + 9.2% Laponite ® OG | good | 36.95 | 2.6 | 942 | 5.49 |
| 6 | ION-A + 18.3% Laponite ® OG | excellent | 53.94 | 13.5 | 1453 | 47.6 |

### Example F

### Mechanical Properties of Ionomer Composites: Creep

Samples of the present ionomer composite and unfilled ionomer controls were prepared in the form of films about 0.5-0.6 mm thick and at least 2.5 cm in diameter using the hot-pressing method described above in Examples B, C, and E. After melt-pressing, the films were dried at 40° C. overnight, then transferred to a dry nitrogen enclosure until tested.

The creep behavior of the films was analyzed at 40° C. and 65° C. with a TA Instruments Q800 Dynamic Mechanical Analyzer. For each test, a specific, pre-selected stress of 0.5 MPa was applied to the film for 20 min at the specified temperature, followed by a 30-min relaxation period at zero applied stress, followed by subsequent stress and relaxation cycles on the same specimen at increasing stress levels of 1.0 and 2.0 MPa. The strain was measured throughout each test to determine how much the given film could be deformed and how much it recovered. The measured strain is an indication of creep.

Incorporation of the nanoparticle filler improved the creep performance, signaled by reduced strain values at 40° C. and more dramatically at 65° C., a temperature close to the onset of the melting transition. The strain values during application of stress and recovery at 65° C. set forth in Table VI show that the strain of the ionomer is significantly reduced by the added nanofiller for samples made with all of the Example 4-6 compositions. The Example 5 sample showed reduction, despite its lower degree of dispersion. The Example 4 and 6 compositions, with well-dispersed filler, showed even greater strain reduction. Data collected at 40° C. showed similar improvements attributable to the Laponite® incorporation.

TABLE VI
Creep Behavior of Ionomer Composites

| | Example | | | | |
|---|---|---|---|---|---|
| Condition | CE1 | CE2 | 4 | 5 | 6 |
| % strain @0.5 MPa 20 min | 56% | 53% | 9% | 10% | 2% |
| % strain after 0.5 MPa load & | 21% | 20% | 4% | 4% | 1% |
| recovery | | | | | |
| % strain @1 MPa 20 min | 125% | 133% | 12% | 15% | 3% |
| % strain after 1 MPa load & | 28% | 33% | 3% | 3% | 1% |
| recovery | | | | | |
| % strain @2 MPa 20 min | stretches | stretches | 39% | 48% | 8% |
| | out | out | | | |
| % strain after 2 MPa load & | − | — | 12% | 14% | 2% |
| recovery | | | | | |

### Example G

### Preparation of Ionomer Composites Using Mixed Aqueous Solvent

Ionomer composites were prepared using a mixed aqueous solvent to disperse Laponite® OG synthetic hectorite platy nanofiller particles in ION-A partially neutralized ionomer.

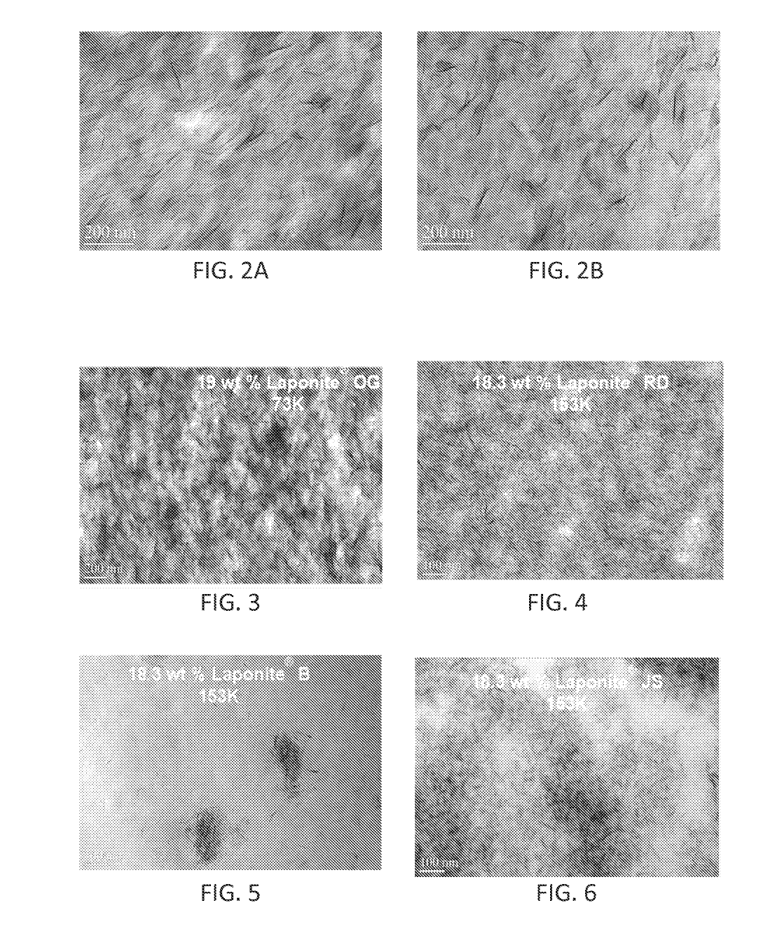

The procedure used generally followed that described above for the preparation of the samples of Example A, with the compositions described in Table VII. The ionomer was dissolved in deionized water at 90° C., as described in Example A, then cooled to room temperature. Then the requisite amount of isopropyl alcohol (IPA) was gradually added with vigorous stirring, so as not to create spots of high IPA concentration that could precipitate polymer. The stirring was continued for about 15 minutes after completing the addition of the IPA. The mixed aqueous solvent was removed with a rotary evaporator and then a vacuum oven, as described for Example A. TEM images shown in FIGS. 2A-2B indicate excellent dispersion and exfoliation of the Laponite® OG nanofiller in the dried ionomer composites of Examples 6A and 6B, respectively.

TABLE VII
Ionomer Composites Prepared with Mixed Aqueous Solvent

| | Example | |
|---|---|---|
| | 6A | 6B |
| Deionized water, g | 123.8 | 82.5 |
| Surlyn ® SEP 1571-5,* g | 16.35 | 16.35 |
| Surlyn ® SEP 1702-1,* g | — | — |
| Isopropyl Alcohol (IPA) (BDH, 99+ %), g | 41.2 | 82.5 |
| Laponite ® OG, g | 1.65 | 1.65 |
| Calculated total wt after drying, G | 18.0 | 18.0 |
| Calculated wt. % Laponite ® OG/dry total | 9.2% | 9.2% |
| Calculated wt. % IPA in mixed solvent | 25.0% | 50.0% |
| Exfoliation, dispersion quality (TEM) | excellent | excellent |

### Example H

### Preparation of an Ionomer Composite Comprising a Water-Dispersed, Ammonium-Neutralized Poly(Ethylene/Acrylic Acid) Ionomer

The amount of polymer in an aqueous dispersion of ION-J was determined by measuring its percentage of solids. A 0.5008-g portion of the dispersion was dried at room temperature and then overnight in a vacuum oven, at 50° C. under vacuum and a slight nitrogen bleed. The dried solids weighed 0.1084 g, corresponding to 21.6 wt. % solids in the as-received dispersion.

Ionomer composite material was produced using ION-J ionomer and Laponite® OG synthetic sodium magnesium silicate (hectorite) using the process generally described in Example A above. To a round-bottom flask equipped with a mechanical stirrer were added sequentially 33.7 g of ION-J ionomer aqueous dispersion and 85.0 g of deionized water. Then 1.70 g of Laponite® OG was added, with the solution being very rapidly stirred to generate a vortex to wet out the powder before it could form clumps. The mixture was stirred rapidly for 30 minutes to thoroughly disperse the Laponite®. The mixture was dried as described in Example A using a rotary evaporator and a vacuum oven. The calculated amount of Laponite® in the dried solids was 19 wt. %.

The TEM images in FIG. 3 show excellent dispersion and exfoliation of Laponite® OG in the ionomer.

### Example J

### Preparation of Ionomer Composites Comprising Laponite® Nanofiller

The method described above in Example G, which employed a mixed aqueous medium (75% H₂O/25% IPA), was repeated to produce samples of Examples 10-12 and 12A, except that the Laponite® OG filler was replaced with three other grades of Laponite® synthetic hectorite, as set forth in Table VIII.

TEM images of the ionomer composites of Examples 10-12 are shown in FIGS. 4, 5, and 6. The Example 10 image (FIG. 4) demonstrates excellent dispersion and exfoliation of Laponite® RD nanoparticles, while the images for the Example 11 (FIG. 5) and Example 12 (FIG. 6) compositions show a partial, but less complete, exfoliation of Laponite® B and JS into individual platelets in the ION-A ionomer. Without being bound by any theory, it is believed that the fluorine substitution and higher CEC in these grades makes them more difficult to disperse than Laponite® OG. The dispersion and exfoliation of a lower concentration of Laponite® RD in Example 12A was also excellent.

TABLE VIII
Compositions of Composites Prepared with Laponite ® Fillers

| | Example No. | | | |
|---|---|---|---|---|
| | 10 | 11 | 12 | 12A |
| Deionized water, g | 123.8 | 123.8 | 123.8 | 123.8 |
| ION-A, g | 7.35 | 7.35 | 7.35 | 16.35 |
| IPA, g | 41.2 | 41.2 | 41.2 | 41.2 |
| Laponite ® RD, g | 1.65 | — | — | 1.65 |
| Laponite ® B, g | — | 1.65 | — | — |
| Laponite ® JS, g | — | — | 1.65 | — |
| Calculated total wt. | 9.0 | 9.0 | 9.0 | 18.0 |
| after drying, g | | | | |
| Calculated wt. % | 18.3% | 18.3% | 18.3% | 9.2% |
| Laponite ®/dry total | | | | |
| Degree of exfoliation (TEM) | excellent | fair | fair | excellent |

### Example K

### Ionomer Composites with Colloidal Silica Nanofiller

As-received samples of Ludox® TM-40, Ludox® TMA, and Ludox® CL aqueous dispersions were diluted with deionized water to provide a concentration of about 5 wt. % silica. These dispersions were then used to prepare composites of ionomer ION-A (Examples 13-16) and Comparative Example CE3, as shown in Table IX.

Each of the samples was prepared using the dilute solution processing generally described in Example A. The requisite ionomer and deionized water were first added sequentially at room temperature and heated while being stirred to dissolve the ionomer. Then the solution was cooled to room temperature. Then the requisite Ludox® colloidal silica dispersion, after dilution with extra water to 5 wt. % silica, was slowly added with continued stirring to insure full dispersion. Thereafter the mixture was dried as before using a rotary evaporator and vacuum oven with a slight nitrogen bleed.

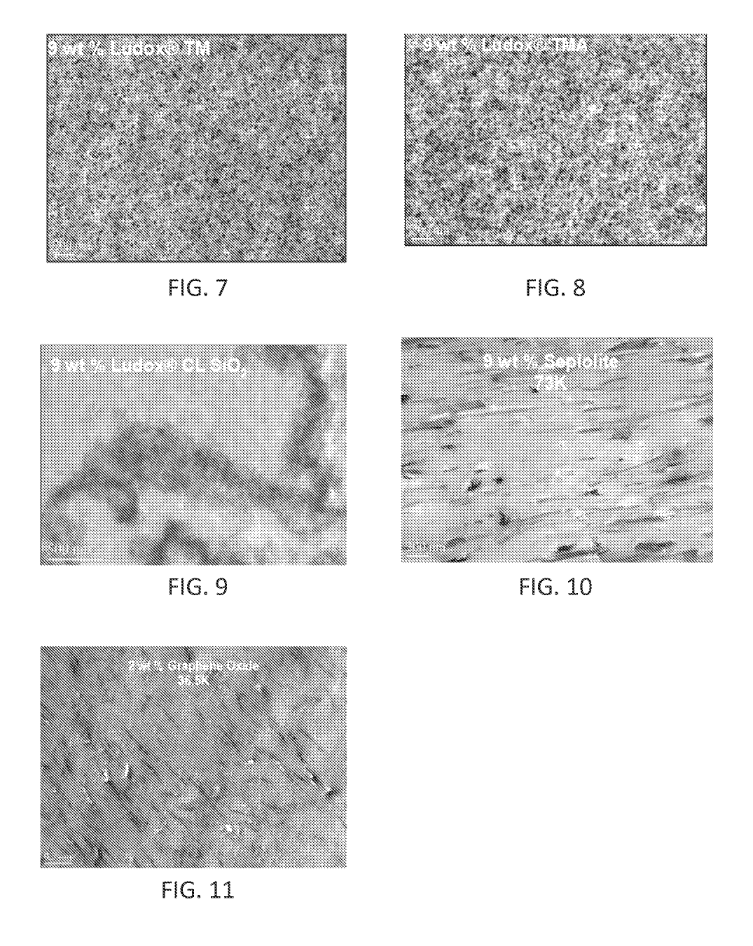

TEM images of the ionomer/silica composites of Examples 13 and 14 (FIGS. 7 and 8) demonstrate excellent dispersion of Ludox® TM-40 and Ludox® TMA in ionomer ION-A. On the other hand, Ludox® CL, in which the colloidal SiO₂ is understood to have been treated to have a cationic, positively charged surface, did not disperse well in ION-A, as shown by the TEM image of the sample of Comparative Example CE3 shown in FIG. 9. This finding indicates that the separate dispersibility of a nanofiller and an ionomer in water or aqueous solution is insufficient to ensure that the materials are mutually dispersible in a similar solution.

TABLE IX
Compositions of Composites Prepared with Colloidal Silica Fillers

| | Example No. | | | | |
|---|---|---|---|---|---|
| | 13 | 14 | 15 | 16 | CE3 |
| Deionized water, g | 133.65 | 133.65 | 133.65 | 133.65 | 133.65 |
| ION-A, g | 16.35 | 16.35 | 15.20 | 15.20 | 16.35 |
| Diluted colloidal | | | | | |
| silica: | | | | | |
| Diluted Ludox ® | 33.0 | — | 68.0 | — | — |
| TM-40, g | | | | | |
| Diluted Ludox ® | — | 33.0 | — | 68.0 | — |
| TMA, g | | | | | |
| Ludox ® CL, g | — | — | — | — | 33.0 |
| Calculated total wt | 18.0 | 18.0 | 18.6 | 18.6 | 18.0 |
| after drying, g | | | | | |
| Calculated wt. % | 9.2% | 9.2% | 18.3% | 18.3% | 9.2% |
| SiO₂/dry total | | | | | |
| Dispersion quality | excellent | excellent | — | — | poor |
| (TEM) | | | | | |

### Example L

### Preparation of a Sepiolite-Ionomer Composite

An aqueous dispersion of Pangel® S9 sepiolite was prepared by mixing 250.0 g of deionized water, 2.5 g of tetrasodium pyrophosphate decahydrate (TSPP), and 7.5 g of Pangel® S9 sepiolite. After mixing under high shear, the mixture was allowed to stand for undissolved solids to settle out. The supernatant liquid was decanted. The solids content was determined as 3.00 wt. % by drying a small portion of the supernatant. Assuming that most of the TSPP remained in the liquid phase, the estimated weight of TSPP in the decanted liquid was subtracted to obtain an estimated sepiolite content of 2.0 wt. %.

Ionomer composites set forth as Examples 17-19 of Table X were then prepared using the dilute solution processing generally described in Example A. The Pangel® S9 sepiolite was introduced from the supernatant liquid dispersion.

Each mixture was dried to afford a solid mixture for analysis of properties and for later use. Each mixture was transferred to a 2-liter round-bottom flask and attached to a rotary evaporator to be dried, with vacuum and heat from a water bath set at 65° C. and gradually raised to a maximum 85° C., to avoid a bumping problem associated with water. The solid product was removed from the flask and dried overnight in vacuum oven, at 50° C. under vacuum and with a slight nitrogen bleed.

A portion of the product of Example 17 was melt-pressed into a 1-mm thick disc with 2-cm diameter. The portion was first preheated between polyimide sheets at 135° C. for 75 sec and then pressed for 60 sec at 10 tons of force to remove most bubbles. The resulting 15-mil (380 μm) thick film was stuffed into a 2-cm circular 1-mm thick aluminum mold constructed from 6″×6″ 40-mil aluminum sheet, with 2.0-cm circle cut in its center, preheated without pressure for 75 sec and then pressed with 10 tons of force for 60 sec.

A sample of the pressed disc of product from Example 17 was analyzed by TEM. The image in FIG. 10 shows excellent dispersion of the sepiolite in the ION-A ionomer.

TABLE X
Preparation of Sepiolite-Containing Composites

| | Example No. | | |
|---|---|---|---|
| | 17 | 18 | 19 |
| Deionized water, g | 110.0 | 90.2 | 66.8 |
| Ionomer ION-A, g | 16.35 | 13.4 | 9.93 |
| Sepiolite supernatant dispersion, g | 57.2 | 133.3 | 49.3 |
| Calculated wt. % sepiolite in supernatant | 2.04% | 2.04% | 2.04% |
| Calculated wt. of sepiolite, g | 1.17 | 2.72 | 1.01 |
| Calculated wt. % sepiolite/dry total | 6.7% | 16.9% | 9.2% |

### Example M

### Preparation of a Graphene Oxide-Ionomer Composite

A graphene oxide-ionomer composite was prepared as Example 20. Using a dilute solution processing method similar to that employed for Example A, 12.25 g of ION-A ionomer was dissolved in 75.0 g of hot deionized water. Then 50.0 g of a 0.5 wt. % dispersion of graphene oxide in water was gradually added with stirring to produce a composite with a calculated 2 wt. % graphene oxide. The aqueous dispersion was then dried in the same manner as described in Example A.

A TEM image of the dried solid of Example 20 is shown in FIG. 11, demonstrating excellent dispersion and exfoliation of the graphene oxide platelets in the ionomer.

### Example N

### Mechanical Properties of Ionomer Composites with Various Fillers: Stress-Strain

Samples of the example compositions listed in Table XI were melt-pressed into 125-μm thick films using the process described above in Example C. The films were aged for at least a week at room temperature after pressing, then equilibrated at 50% relative humidity for at least a day before testing. Small dogbone specimens of the films were tested on an Instron machine at 75° C. and 50% relative humidity in accordance with ASTM D1708, as described in Example C above. The average results and standard deviations are reported in Table XI.

In general the layered silicate nanofillers elevated the Young's modulus and stress at yield of the parent ionomer (CE1), but the colloidal silica nanofillers gave relatively little change in these samples, all prepared by dilute solution processing. The colloidal silica gave modest increase in modulus but with less sacrifice in elongation at break.

TABLE XI
Mechanical Properties of Selected Composites

| | | Young's | Stress | Stress | Elongation |
|---|---|---|---|---|---|
| | | Modulus | at Yield | at Break | at Break |
| Example | Material | (MPa) | (MPa) | (MPa) | (%) |
| CE1 | ION-A pellets | 230 ± 20 | 14 | 18 ± 1 | 260 ± 30 |
| CE2 | Water-processed ION-A | 230 ± 10 | 13 | 16 ± 3 | 220 ± 70 |
| 13 | ION-A + 9% Ludox ® TM | 226 | 13 | 15 | 200 |
| 15 | ION-A + 18% Ludox ® TM | 258 | 14 | 13 | 147 |
| 14 | ION-A + 9% Ludox ® TMA | 216 | 13 | 16 | 233 |
| 16 | ION-A + 18% Ludox ® TMA | 287 | 14 | 14 | 140 |
| 19 | ION-A + 9% sepiolite | 545 | 20 | 19 | 165 |
| 18 | ION-A + 17% sepiolite | 619 | 19 | 17 | 107 |
| 12A | ION-A + 9% Laponite ®RD | 326 | 15 | 15 | 23 |
| 10 | ION-A + 18% Laponite ®RD | 499 | 19 | 16 | 123 |

### Example 0

### Mechanical Properties of Ionomer Composites with Various Nanofillers: Dynamic Mechanical Analysis

Samples of the example compositions listed in Table XII were melt-pressed into films 0.5-0.6 mm thick and at least 2.5 cm in diameter using the method set forth generally in Example E. The films were dried at 40° C. overnight, then transferred to a dry nitrogen enclosure until tested. DMA testing was carried out as described in Example E.

The DMA data shown in Table XII demonstrate that the presence of all the nanofillers elevated the storage and loss moduli of ION-A ionomer at 25° C. and 95° C.

TABLE XII
Dynamic Mechanical Analysis of Selected Composites

| | | Loss | Loss | Storage | Storage |
|---|---|---|---|---|---|
| | | Modulus | Modulus | Modulus | Modulus |
| | | @ 25° C. | @ 95° C. | @ 25° C. | @ 95° C. |
| Example | | (MPa) | (MPa) | (MPa) | (MPa) |
| CE1 | ION-A pellets | 13.81 | 0.77 | 324 | 1.44 |
| CE2 | Water-processed ION-A | 33.2 | 0.81 | 652 | 1.43 |
| 13 | ION-A + 9% Ludox ® TM | 38.5 | 1.1 | 576 | 2.1 |
| 15 | ION-A + 18% Ludox ® TM | 46.3 | 1.4 | 657 | 2.9 |
| 14 | ION-A + 9% Ludox ® TMA | 46.9 | 1 | 684 | 1.9 |
| 16 | ION-A + 18% Ludox ® TMA | 34.3 | 1.4 | 633 | 2.6 |
| 19 | ION-A + 9% sepiolite | 54 | 6.3 | 1486 | 14.1 |
| 18 | ION-A + 17% sepiolite | 118.4 | 14.6 | 1609 | 38.3 |
| 12A | ION-A + 9% Laponite ® RD | 41.6 | 2.1 | 705 | 4.7 |
| 10 | ION-A + 18% Laponite ® RD | 53.7 | 8.3 | 852 | 25.8 |

### Example P

### Manufacture of Ionomer/Hydrophilic Layered Silicate Composites by Melt Extrusion

A ZSK-18 mm intermeshing, co-rotating twin-screw extruder (Coperion Corp.) with a Length/Diameter (L/D) ratio of 41 was used to make water-dispersible ionomer/hydrophilic nanoparticle composites using a melt extrusion process. The process included water injection and removal for some samples. A conventional screw configuration provided: (i) a solid transport zone to convey ionomer pellets and nanofiller from a first feed port; (ii) a melting section comprising a combination of kneading blocks and multiple reverse pumping elements to create a seal to minimize water vapor escape; (iii) a melt conveying and liquid injection region; (iv) an intensive mixing section comprising multiple combinations of kneading blocks, gear mixers, and reverse pumping elements to promote particle dispersion and distribution, polymer dissolution, and water diffusion; (v) one or two melt degassing and water removal zones; and (vi) a melt pumping section. The melt-processed material was then extruded through a die to form strands that were quenched and cut into pellets.

In operation, feedstock ION-B ionomer pellets (designated as Comparative Example CE4) and solid powders were metered into the first feed port of the extruder using separate loss-in-weight feeders (KTron Corp.). As indicated in Table XIII, the processing of Examples 21-23 included injection of deionized (de-mineralized) water into the extruder downstream of the melting zone using a positive displacement pump; Example 20 was processed without water injection. No attempt was made to exclude oxygen from the extruder. Two vacuum vent zones were used to extract water, volatile gases, and entrapped air. A short mixing section with a reverse pumping element melt seal separated the degassing zones. For the samples of Example P, barrel temperatures were profiled in a range from 120 to 220° C., depending on heat transfer and thermal requirements for melting, liquid injection, mixing, water removal, and polymer flow through the die. The throughput was fixed at 3 lb/h (1.36 kg/h) and the screw rotational speed was 250 RPM. Composites with filler concentrations of 5 and 10 wt. % were produced. No organic surface modifiers were used or added to the extrusion process.

Comparative Examples CE5 and CE6 were made using the same ionomer and extrusion processing conditions, but without the nanofiller additives, and without and with water injection, respectively.

TABLE XIII
Ionomer Composites with Platy Nanofillers

| Ex. | | |
|---|---|---|
| No. | Material | Processing |
| CE4 | ION-B | Feedstock |
| CE5 | ION-B | Extruded, 3 lb/hr/250 RPM |
| CE6 | ION-B | Extruded, 20 mL/min H₂O |
| | | injection |
| 20 | ION-B + Cloisite ® | Extruded (no H₂O) |
| | Na⁺ MMT, 5 wt. % | |
| 21 | ION-B + Cloisite ® | Extruded, 20 mL/min H₂O |
| | Na⁺ MMT, 5 wt. % | injection |
| 22 | ION-B + Cloisite ® | Extruded, 20 mL/min H₂O |
| | Na⁺ MMT, 10 wt. % | injection |
| 23 | ION-B + Laponite ® | Extruded, 20 mL/min H₂O |
| | OG hectorite, 10 wt. % | injection |

The resulting extruded ionomer composite pellets were then dried, using standard conditions for the ionomers used, and thereafter injection-molded into ASTM D638 Type I tensile bar test specimens using an Arburg 1.5 oz shot Allrounder® machine operated with standard settings. For comparison, samples for Comparative Example CE4 were injection-molded under similar conditions using the as-received feedstock pellets of ION-B ionomer that had not been given any further extrusion processing.

All the compositions of Examples 20-23 and Comparative Examples CE4-CE6 could be injection molded or made into films using conventional melt processing equipment operating under conditions recommended for commercial ionomer resins. The tensile bars did not exhibit noticeable defects (flash, sink marks, flow marks, and the like), shrinkage, warpage or short shots that could be induced by significant increases in melt viscosity at shear or extensional rates experienced in the equipment, or by excessive levels of moisture, entrapped air, or other volatile gases.

Tensile properties were measured on specimens conditioned to 50% relative humidity (RH) using an Instru-Met 1123 load frame operating at a cross-head speed of 2 inches/minute. Young's modulus (E) (estimated by the secant method in the linear elastic region of the stress-strain curves), yield stress, and strain at break (% elongation) are listed in Table XIV. For each example, the tensile data were determined by averaging results for six tensile specimens.

TABLE XIV
Tensile and optical properties of ionomer composites with platy nanofillers

| | | | | Strain @ | | | | Haze | WI | YI | YI |
|---|---|---|---|---|---|---|---|---|---|---|---|
| Ex. | Filler | E | YS | Break | | Color | Haze | ASTM | ASTM | ASTM | ASTM |
| No. | (wt. %) | (MPa) | (MPa) | (% elong.) | E/E₀ | Code | Code | D1003 | E313 | E313 | D1925 |
| CE4 | — | 490.6 | 22.2 | 64.5 | 1.00 | 0 | 0 | 1.11 | 85.05 | 1.92 | 1.76 |
| CE5 | — | 448.3 | 21.7 | 61.8 | 0.91 | 0 | 0 | | | | |
| CE6 | — | 446.5 | 21.5 | 63.8 | 0.91 | 0 | 0 | 2.08 | 83.49 | 2.09 | 1.97 |
| 20 | 5.0 | 482.8 | 21.7 | 64.7 | 0.98 | 3 | 5 | | | | |
| 21 | 5.0 | 591.2 | 28.3 | 79.9 | 1.21 | 3 | 3 | | | | |
| 22 | 10.0 | 744.3 | 33.9 | 102.0 | 1.52 | 4 | 4 | | | | |
| 23 | 10.0 | 771.5 | 23.2 | 48.6 | 1.57 | 0.5 | 1 | 2.72 | 80.36 | 2.73 | 2.79 |

The relative modulus (E/E₀) was calculated using the modulus (E₀) obtained for samples made with Comparative Example CE4, the as-received feedstock ionomer without filler or further extrusion processing. A semi-quantitative visual ranking of clarity (haze) and coloration of the nanofilled tensile bars was made using scores ranging from 0 (transparency or color matching unfilled controls) to 5 (nearly opaque or dark brown in color). A value of 0.5 indicated that a very slight coloration or haze could be detected by visual observation.

For several compositions, dried pellets were compression molded into 0.25 mm thick films in a press with platens heated to 190° C., as described generally in Examples B-E above. The film samples were used to measure haze and color using the same standard light spectrometric techniques described above in Example B. Colorimetric measures of haze (ASTM Standard D1003), whiteness index (WI, ASTM Standard E313) and yellowness index (YI, ASTM Standards E313 and D1925) were recorded as listed in Table XIV.

Examples 20-22 were made using ION-B ionomer and an unmodified montmorillonite (MMT) clay, Cloisite® Na⁺ MMT. Example 20, which contained 5 wt. % MMT, was made without water injection and produced composites with very poor dispersion quality, as indicated by the haze and the tensile properties with a small increase in Young's modulus and no improvement in yield stress or elongation at break. All the MMT samples exhibited high levels of haze and color. Examples 21 and 22 (5 and 10 wt. % MMT, respectively) were extruded with water injection at 20 mL/min, and exhibited a significant improvement in the dispersion quality, as indicated by a reduction in haze and an increase in tensile modulus, yield stress, and elongation at break. The extent of MMT exfoliation was increased with water injection. Haze and color increased with MMT concentration from 5 to 10 wt. %.

Example 23 was made using ION-B ionomer and 10 wt. % unmodified synthetic hectorite (Laponite® OG). It was extruded with water injection at 20 mL/min. Modulus was slightly greater than that of the 10 wt. % MMT sample. There was a slight increase in yield stress and a reduction in the elongation at break. The hectorite-containing sample exhibited a slight increase in haze and a very small change in color, but had optical properties far superior to those of the MMT composites.

The materials of Comparative Examples CE4 and CE6 (unfilled ION-B) and Example 23 (10 wt. % synthetic hectorite composite) were also compression molded into 0.25 mm thick films. Extrusion of the ION-B ionomer increased haze and yellowness indices slightly and reduced the whiteness index proportionally. The addition of 10 wt. % synthetic hectorite caused similar changes relative to the extruded control.

### Example Q

### Manufacture of Ionomer/Vermiculite Composites by Melt Extrusion

The melt compounding and water injection and removal configuration generally described in Example P was used to prepare water-dispersible ionomer/vermiculite compositions and masterbatches, as listed in Table XV. The operating conditions were the same as those used in Example P, except that only the ionomer was fed into the first feed port of the extruder. The nanofiller, supplied as an aqueous slurry containing 14 wt. % vermiculite (concentrated Microlite® 923) was injected into the extruder and dispersed in the molten ionomer. The slurry injection flow rate was increased to introduce a desired level of vermiculite into the extruder. This also increased the water concentration in the extruder, so the ionomer to vermiculite to water ratios changed accordingly. Examples 24-26 were made with ION-B ionomer, while corresponding Examples 27-29 were made with ION-A ionomer. Comparative Examples CE7-CE9 correspond to Comparative Examples CE4-CE6, but with ION-A ionomer replacing ION-B ionomer.

TABLE XV
Ionomer Composites with Vermiculite Nanofiller

| Ex. No. | Ionomer | Filler | Processing |
|---|---|---|---|
| CE4 | ION-B | — | Feedstock |
| CE5 | ION-B | — | Extruded, 3 lb/hr/250 RPM |
| CE6 | ION-B | — | Extruded, 20 mL/min H₂O injection |
| 24 | ION-B | MicroLite ® | Extruded (no H₂O) |
| | | 923, 5 wt. % | |
| 25 | ION-B | MicroLite ® | Extruded, 20 mL/min H₂O injection |
| | | 923, 10 wt. % | |
| 26 | ION-B | MicroLite ® | Extruded, 20 mL/min H₂O injection |
| | | 923, 14 wt. % | |
| CE7 | ION-A | — | Feedstock |
| CE8 | ION-A | — | Extruded, 3 lb/hr/250 RPM |
| CE9 | ION-A | — | Extruded, 20 mL/min H₂O injection |
| 27 | ION-A | MicroLite ® | Extruded (no H₂O) |
| | | 923, 5 wt. % | |
| 28 | ION-A | MicroLite ® | Extruded, 20 mL/min H₂O injection |
| | | 923, 10 wt. % | |
| 29 | ION-A | MicroLite ® | Extruded, 20 mL/min H₂O injection |
| | | 923, 14 wt. % | |

Extruded pellet samples of the inventive and comparative examples were dried and injection molded into ASTM tensile bars using the same procedures described in Example P. All compositions could be injection molded or made into films using conventional melt processing equipment operating under conditions recommended for commercial ionomer resins. Tensile bars again did not exhibit noticeable defects (flash, sink marks, flow marks, and the like), shrinkage, warpage or short shots that could be induced by significant increases in melt viscosity at shear or extensional rates experienced in the equipment, or by excessive levels of moisture, entrapped air, or other volatile gases.

Tensile and optical properties were measured using the methods described in Example P. As seen in Table XVI, all composite samples containing vermiculite had significant increases in modulus, yield stress and elongation at break. For each sample, the ratio E/E₀ is calculated relative to the modulus for the control made with the given base ionomer. In addition, for ION-A-based Comparative Examples CE7-CE9 and Examples 27-29, the energy to break and the relative energy to break (normalized to the unfilled ionomer) were also obtained. As seen in Table XVI, these properties are also improved by the nanofiller addition. However, all the samples were brown in color and went from being nearly opaque to completely opaque with increasing vermiculite concentration.

TABLE XVI
Tensile and optical properties of ionomer composites with vermiculite nanofiller

| | | | | | Strain @ | | Energy | Relative | | |
|---|---|---|---|---|---|---|---|---|---|---|
| | | Filler | E | YS | Break | | @Break | Energy | Color | Haze |
| Ex. No. | Ionomer | (wt. %) | (MPa) | (MPa) | (% elong.) | E/E₀ | (J) | @ Break | Code | Code |
| CE4 | ION-B | — | 490.6 | 22.2 | 64.5 | 1.00 | | | 0 | 0 |
| CE5 | ION-B | — | 448.3 | 21.7 | 61.8 | 0.91 | | | 0 | 0 |
| CE6 | ION-B | — | 446.5 | 21.5 | 63.8 | 0.91 | | | 0 | 0 |
| 24 | ION-B | 5.0 | 570.4 | 23.1 | 114.1 | 1.16 | | | 5 | 4 |
| 25 | ION-B | 10.0 | 690.3 | 24.7 | 144.2 | 1.41 | | | 5 | 5 |
| 26 | ION-B | 14.0 | 746.0 | 30.1 | 114.0 | 1.52 | | | 5 | 5 |
| CE7 | ION-A | — | 418.6 | 17.7 | 134.4 | 1.00 | 94.2 | 1.00 | | |
| CE8 | ION-A | — | 518.4 | 20.4 | 149.2 | 1.24 | 109.5 | 1.16 | 0 | 0 |
| CE9 | ION-A | — | 469.5 | 19.3 | 159.4 | 1.12 | 114.0 | 1.21 | 0 | 0 |
| 27 | ION-A | 5.0 | 653.4 | 19.8 | 165.2 | 1.56 | 171.4 | 1.82 | 5 | 4 |
| 28 | ION-A | 10.0 | 803.4 | 24.1 | 190.0 | 1.92 | 173.4 | 1.84 | 5 | 5 |
| 29 | ION-A | 14.0 | 972.7 | 25.5 | 137.9 | 2.32 | 130.4 | 1.39 | 5 | 5 |

### Example R

### Manufacture of Ionomer/Colloidal Silica Composites by Melt Extrusion

The configuration and operating conditions used for melt compounding and water injection and removal in Example Q were repeated to prepare ION-B ionomer/colloidal silica compositions and masterbatches as shown in Table XVII. Once again, only the ionomer pellets were fed into the first feed port of the extruder, while an aqueous suspension of Ludox® TM-40 colloidal silica was injected into the extruder and dispersed in the molten ION-B ionomer. The suspension injection flow rate was increased to introduce more silica into the extruder. This also increased the water concentration in the extruder, so the water dispersible polymer to silica to water ratios changed accordingly. Samples were made with silica concentrations of 10, 20, 30 wt. % in ION-B ionomer (Examples 30-32).

Extruded pellet samples were dried and injection molded into ASTM tensile bars using the same procedures described in Example P. All compositions could be injection molded or made into films using conventional melt processing equipment operating under conditions recommended for commercial ionomer resins. Tensile bars again did not exhibit noticeable defects (flash, sink marks, flow marks, and the like), shrinkage, warpage or short shots that could be induced by significant increases in melt viscosity at shear or extensional rates experienced in the equipment, or by excessive levels of moisture, entrapped air, or other volatile gases.

Tensile and optical properties were measured using the methods described in Example P. As set forth in Table XVII, all the composite samples containing colloidal silica in ION-B ionomer had significant and unexpected increases in Young's modulus and yield stress over the reiterated values for Comparative Examples CE4-CE6. The elongations at break increased for samples containing 10 and 20 wt. % colloidal silica particles, but decreased at the 30 wt. % concentration. Composites theory predicts that well-dispersed spherical particles should provide very little tensile reinforcement. The modulus data thus indicate that an anisotropic structure having an effective aspect ratio aligned in the tensile strain direction was created.

The semi-quantitative haze and color evaluations listed in Table XVII show that the composites containing Ludox® TM-40 colloidal silica had little coloration, but high levels of haze. The haze would indicate that the nanoparticles formed an agglomerated or flocculated microstructure. A slight yellow tint was caused by the color of the TM-40 colloidal suspension itself

TABLE XVII
Tensile and optical properties of ionomer composites
with colloidal silica nanofiller

| | | | | Strain @ | | | |
|---|---|---|---|---|---|---|---|
| | Filler | E | YS | Break | | Color | Haze |
| Ex. No. | (wt. %) | (MPa) | (MPa) | (% elong.) | E/E₀ | Code | Code |
| CE4 | — | 490.6 | 22.2 | 64.5 | 1.00 | 0 | 0 |
| CE5 | — | 448.3 | 21.7 | 61.8 | 0.91 | 0 | 0 |
| CE6 | — | 446.5 | 21.5 | 63.8 | 0.91 | 0 | 0 |
| 30 | 10.0 | 564.2 | 23.3 | 71.9 | 1.15 | 0.5 | 2 |
| 31 | 20.0 | 694.3 | 27.5 | 76.3 | 1.42 | 0.5 | 3 |
| 32 | 30.0 | 906.7 | 28.1 | 22.9 | 1.85 | 0.5 | 3 |

### Example S

### Manufacture of Ionomer/Colloidal Silica Composites by Melt Extrusion

The configuration and operating conditions used for melt compounding and water injection and removal in Examples Q and R were repeated to prepare ION-A ionomer/colloidal silica compositions and masterbatches as shown in Table XVIII. Once again, only the ionomer pellets were fed into the first feed port of the extruder, while an aqueous suspension of colloidal silica (Ludox® TM-40) was injected into the extruder and dispersed in the molten ION-A ionomer. Example 33 was processed with the as-received Ludox® TM-40, which contained about 40 wt. % silica. This condition produced a composite with high haze. In order to increase the concentration of water in the compounding process, Examples 34 and 35 were produced with the TM-40 diluted with deionized water to 10 and 20 wt. % silica content, respectively. These diluted suspensions were injected into the extruder in the same manner, with the amounts adjusted to give the desired final filler loading.

TABLE XVIII
Ionomer Composites Comprising ION-A Ionomer and Colloidal
Silica Nanofiller

| | | Filler | Filler | |
|---|---|---|---|---|
| | | Content | Content In | |
| | | In Feedstock | Composite | |
| Ex. No. | Filler | (wt. %) | (wt. %) | Processing |
| CE7 | — | — | — | Feedstock |
| CE8 | — | — | — | Extruded, 3 lb/ |
| | | | | hr/250 RPM |
| CE9 | — | — | — | Extruded, 20 mL/ |
| | | | | min H₂O |
| | | | | injection |
| 33 | Ludox ® TM-40 | 40.0 | 10.0 | Extruded |
| 34 | Ludox ® TM-40 | 10.0 | 10.0 | Extruded |
| 35 | Ludox ® TM-40 | 20.0 | 20.0 | Extruded |

Extruded pellet samples were dried and injection molded into ASTM tensile bars using the same procedures described in Example P. All compositions could be injection molded or made into films using conventional melt processing equipment operating under conditions recommended for commercial ionomer resins. Tensile bars exhibited no defects (flash, sink marks, flow marks, and the like) that could be induced by significant increases in melt viscosity or by excessive levels of moisture, entrapped air, or other volatile gases.

Tensile, physical, and optical properties were measured using the methods described for Example P. As set forth in Table XIX, all the composite samples containing colloidal silica in ION-B ionomer had significant and unexpected increases in Young's modulus and yield stress over values for Comparative Examples CE7-CE9, made with the same ionomer but without filler. The sample containing 10 wt. % silica that was made by injecting the 40 wt. % concentration colloidal silica suspension had a reduction in the elongation at break and energy to break. On the other hand, the sample containing 10 wt. % silica made by injecting the 10 wt. % concentration colloidal silica suspension had significant increases in the elongation at break and energy to break, indicating a measurable change in the microstructure. The sample containing 20 wt. % silica made by injecting the 20 wt. % concentration colloidal silica suspension had significant increase in the modulus (relative modulus E/E₀=1.92) with a loss in elongation at break and a slight reduction in the energy to break. The modulus data suggest that an anisotropic structure was created that had an effective aspect ratio aligned in the tensile strain direction.

The semi-quantitative haze and color evaluations listed in Table XIX show that the composites containing Ludox® TM-40 silica had little coloration, but high levels of haze. The haze would indicate that the nanoparticles formed an agglomerated or flocculated microstructure. A slight yellow tint was caused by the color of the TM-40 colloidal suspension itself. Example 33 (10 wt. % silica made by injecting the 40 wt. % concentration colloidal silica suspension) had very high haze. Example 34 (10 wt. % silica made by injecting the 10 wt. % concentration colloidal silica suspension) had significantly less haze than Example 33, further indicating a measurable change in microstructure affecting the optical properties. Example 35 (20 wt. % silica made by injecting the 20 wt. % concentration colloidal silica suspension) had increased haze.

Compression-molded film samples with 0.25 mm thickness were made with some of the samples using the procedure described in Example P. Optical data on these samples set forth in Table XIX show an increase in haze, a decrease in WI, and a slight increase in YI in all the silica composite samples.

Melt Flow Rate (MFR) measurements were made on selected samples following the method described in ASTM Standard D1238 at 190° C. using a 2.16 kg weight. The MFR of the composites containing 10 and 20 wt. % silica decreased to 3.06 and 2.66 g/10 min. respectively (Table XIX). However, these MFR values are still well within the range in which composites can be melt processed using conventional equipment operating under routine operating conditions (e.g, barrel temperatures, flow rates, screw speeds, and the like) showing that the colloidal silica composites with high filler loadings can readily be processed.

TABLE XIX
Physical and optical properties of Ionomer Composites Comprising
ION-A Ionomer and Colloidal Silica Nanofiller

| | | | | Haze | WI | YI | YI | MFR |
|---|---|---|---|---|---|---|---|---|
| | Filler | | Haze | ASTM | ASTM | ASTM | ASTM | ASTM |
| Ex. No. | (wt. %) | Color Code | Code | D1003 | E313 | E313 | D1925 | D1238 |
| CE7 | — | 0 | 0 | 3.18 | 84.42 | 2.04 | 1.92 | 5.60 |
| CE8 | — | 0 | 0 | | | | | |
| CE9 | — | 0 | 0 | 3.65 | 83.65 | 2.09 | 1.98 | |
| 33 | 10.0 | 0.5 | 4 | | | | | |
| 34 | 10.0 | 0.5 | 2 | 4.41 | 77.43 | 3.34 | 3.58 | 3.06 |
| 35 | 20.0 | 0.5 | 3 | 8.74 | 75.32 | 3.83 | 4.10 | 2.66 |

This example thus demonstrates that oxide-filled composites can be made by injecting colloidal suspensions into a molten, water-dispersible ionomer in a one-step melt extrusion process with water removal. A wide range of compositions can be made, including compositions suitable as masterbatch concentrates. Structured or anisotropic morphologies of spherical particles can be altered by controlling the amount of water injected into the extrusion process, resulting in composites with different mechanical and optical properties.

### Example T

### Manufacture of Ionomer/Layered Silicate Composites by Melt Extrusion

The configuration and operating conditions used for melt compounding and water injection and removal in Example P were repeated to prepare additional ionomer composite compositions and masterbatches, as listed in Table XX. The compositions comprised ION-A ionomer and fillers of hydrophilic layered silicate nanoparticles of Cloisite® Na⁺ MMT, Laponite® OG synthetic hectorite, and Pangel® S9 sepiolite, which were added as dry powders into the extruder feed port.

TABLE XX
Ionomer Composites with Layered Silicate Nanofillers

| | | Amount | |
|---|---|---|---|
| Ex. No. | Filler Type | (wt. %) | Processing |
| CE4 | — | — | Feedstock |
| CE5 | — | — | Extruded, 3 lb/hr/250 RPM |
| CE6 | — | — | Extruded, 20 mL/min H₂O |
| | | | injection |
| 36 | Cloisite ® Na⁺ MMT | 5 | Extruded (no H₂O) |
| 37 | Cloisite ® Na⁺ MMT | 5 | Extruded, 20 mL/min H₂O |
| | | | injection |
| 38 | Cloisite ® Na⁺ MMT % | 10 | Extruded, 20 mL/min H₂O |
| | | | injection |
| 39 | Laponite ® OG hectorite | 5 | Extruded (no H₂O) |
| 40 | Laponite ® OG hectorite | 5 | Extruded, 20 mL/ |
| | | | min H₂O injection |
| 41 | Laponite ® OG hectorite | 10 | Extruded, 20 mL/ |
| | | | min H₂O injection |
| 42 | Pangel ® S9 sepiolite | 5 | Extruded (no H₂O) |
| 43 | Pangel ® S9 sepiolite | 5 | Extruded, 20 mL/ |
| | | | min H₂O injection |
| 44 | Pangel ® S9 sepiolite | 10 | Extruded, 20 mL/ |
| | | | min H₂O injection |

Extruded pellet samples were dried and injection molded into ASTM tensile bars using the same procedures described in Example P. Selected pellet samples were compression molded into 0.25 mm thick films using the procedure described above in Examples B-E and P. Tensile, physical, and optical properties were measured using the methods described in Examples B and P, yielding data set forth in Tables XXI and XXII. All the compositions could be injection molded or made into films using conventional melt processing equipment operating under conditions recommended for commercial ionomer resins. Tensile bars again did not exhibit noticeable defects (flash, sink marks, flow marks, and the like), shrinkage, warpage or short shots that could be induced by significant increases in melt viscosity at shear or extensional rates experienced in the equipment, or by excessive levels of moisture, entrapped air, or other volatile gases.

TABLE XXI
Tensile properties of Ionomer Composites
with Layered Silicate Nanofillers

| | | | | Strain @ | | Energy | Relative |
|---|---|---|---|---|---|---|---|
| Ex. | Filler | E | YS | Break | | @Break | Energy |
| No. | (wt. %) | (MPa) | (MPa) | (% elong.) | E/E₀ | (J) | @Break |
| CE7 | — | 418.6 | 17.7 | 134.4 | 1.00 | 94.2 | 1.00 |
| CE8 | — | 518.4 | 20.4 | 149.2 | 1.24 | 109.5 | 1.16 |
| CE9 | — | 469.5 | 19.3 | 159.4 | 1.12 | 114.0 | 1.21 |
| 36 | 5.0 | 586.7 | 22.5 | 141.4 | 1.40 | 111.9 | 1.19 |
| 37 | 5.0 | 665.3 | 23.2 | 160.6 | 1.59 | 142.7 | 1.52 |
| 38 | 10.0 | 838.8 | 26.2 | 145.3 | 2.00 | 154.1 | 1.64 |
| 39 | 5.0 | 550.3 | 21.3 | 133.2 | 1.31 | 100.5 | 1.07 |
| 40 | 5.0 | 718.8 | 23.9 | 123.8 | 1.72 | 114.9 | 1.22 |
| 41 | 10.0 | 930.2 | 27.2 | 95.3 | 2.22 | 101.9 | 1.08 |
| 42 | 5.0 | 637.5 | 22.7 | 138.7 | 1.52 | 120.8 | 1.28 |
| 43 | 5.0 | 741.1 | 24.1 | 129.0 | 1.77 | 124.9 | 1.33 |
| 44 | 10.0 | 1112.7 | 32.0 | 67.2 | 2.66 | 85.3 | 0.91 |

TABLE XXII
Physical and optical properties of Ionomer Composites
with Layered Silicate Nanofillers

| | | | | Haze | WI | YI | YI | MFR |
|---|---|---|---|---|---|---|---|---|
| | Filler | Color | | ASTM | ASTM | ASTM | ASTM | ASTM |
| Ex. No. | (wt. %) | Code | Haze Code | D1003 | E313 | E313 | D1925 | D1238 |
| CE7 | — | 0 | 0 | 3.18 | 84.42 | 2.04 | 1.92 | 5.60 |
| CE8 | — | 0 | 0 | | | | | |
| CE9 | — | 0 | 0 | 3.65 | 83.65 | 2.09 | 1.98 | |
| 36 | 5 | 3 | 4 | | | | | |
| 37 | 5 | 3 | 3 | 11.43 | 60.35 | 7.50 | 8.30 | 4.67 |
| 38 | 10 | 3 | 4 | 21.57 | 43.27 | 11.80 | 13.34 | 4.35 |
| 39 | 5 | 0 | 4 | 13.55 | 76.75 | 3.19 | 3.44 | 5.01 |
| 40 | 5 | 0 | 0 | 2.51 | 83.77 | 2.21 | 2.03 | 3.38 |
| 41 | 10 | 0 | 0 | 2.54 | 82.59 | 2.37 | 2.33 | 2.07 |
| 42 | 5 | 3 | 3 | | | | | |
| 43 | 5 | 3 | 2 | | | | | 3.94 |
| 44 | 10 | 3 | 3 | | | | | |

A composite containing ION-A ionomer and unmodified Cloisite® Na⁺ MMT (Example 36) made without water injection produced composites with very poor dispersion quality, as indicated by its high level of haze. The tensile data showed increases in Young's modulus, yield stress and elongation at break. All MMT samples exhibited high levels of haze and color in tensile bars and film samples. Water injection (20 mL/minute) followed by effective water removal in the vacuum zones made a significant improvement in the dispersion quality, as indicated by a reduction in haze and an increase in tensile modulus, yield stress and elongation at break for Examples 37 and 38. The extent of MMT exfoliation was increased with water injection. Haze and color increased with MMT concentration from 5 to 10 wt. %. Film sample Whiteness Index (WI) decreased significantly and Yellow Index (YI) measures increased significantly with MMT addition (Table XXII).

An ION-A ionomer composite containing 5 wt. % unmodified synthetic hectorite (Laponite® OG) and made without water injection (Example 39) produced composites with very poor dispersion quality, as indicated by high levels of haze in both tensile bars and compression-molded films. The film WI decreased and the YI measures increased in the poorly dispersed composite. The composite sample did show an increase in Young's modulus and yield stress with no loss in the elongation at break or the energy to break measures.

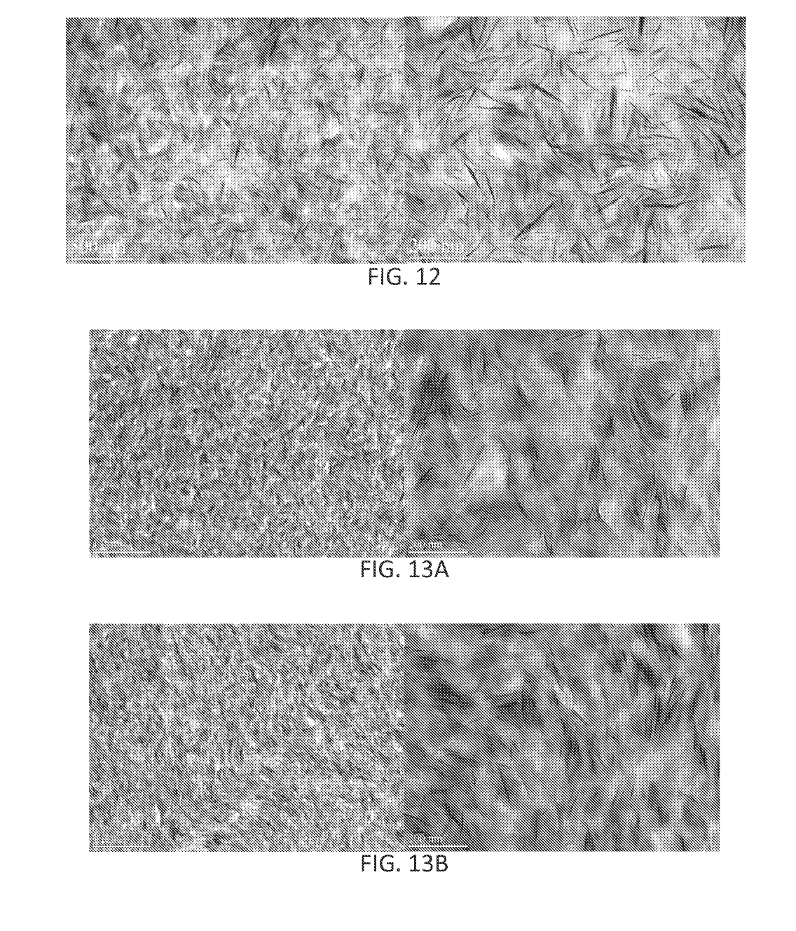

ION-A ionomer composites containing 5 and 10 wt. % unmodified synthetic hectorite (Laponite® OG) (Examples 40 and 41) were made, but with water injection (20 mL/minute) and removal as described above. Injection-molded tensile bars and compression-molded films showed almost no change in optical properties at both concentrations. The WI and YI values showed minor, insignificant changes relative to the unfilled ION-A ionomer control sample. There was no visually observable change in tensile bar color or haze using the semi-quantitative evaluation method. FIG. 12 shows TEM images taken at two magnifications on a specimen prepared from an extruded pellet sample of the ION-A/10 wt. % Laponite® OG synthetic hectorite composite of Example 41. The TEM images confirm that the water injection and removal method produced a partially exfoliated microstructure consisting primarily of a large number of individual platelets and small tactoids made of several platelets. The Laponite® particles have a high aspect ratio, leading to good reinforcement as measured by the tensile properties. These samples have a composite morphology similar to that of samples made by the dilute solution method (see Example A above).

The 5 wt. % synthetic hectorite sample (Example 40) had a significant increase in the modulus compared to the unfilled controls (Comparative Examples CE7-CE9) and the 5 wt. % sample made without water injection. Modulus increased significantly with increasing hectorite concentration (Example 39). Yield stress increased with increasing hectorite concentration. There was a slight decrease in the elongation at break with increasing hectorite concentration. Toughness as measured by the energy to break remained effectively unchanged. It is thus seen that a melt compounding process comprising water injection and removal can be used to produce ionomer/synthetic hectorite composites that exhibit significant tensile reinforcement, while preserving high toughness, desirable optical properties, and good melt processability in shaping and forming operations.

ION-A composites containing 5 and 10 wt. % unmodified sepiolite (Pangel® S9) (Examples 42-44) were made with and without the water injection (20 mL/minute) and removal as described above. With both processing conditions and compositions, sepiolite increased the modulus and yield stress. For the 5 wt. % sepiolite composites, water injection and removal further increased the modulus and yield stress, preserved the toughness, and reduced the haze slightly.

MFR measurements were made on selected samples following ASTM D1238, as described in Example S. The values listed in Table XXII show a decrease in MFR with increasing filler concentration. However, the decrease in MFR from the 5.60 g/10 min of Comparative Example CE7 to the 2.07 g/10 min of Example 41 was well within a range wherein most forming and shaping processes can be operated with minor changes in typical process control settings, as discussed above.

This example demonstrates that suitable ionomers and a variety of unmodified, hydrophilic layered silicates can be dispersed effectively using a melt compounding method that comprises water injection and removal. Tensile properties, properties of commercial importance and a measure of the microstructure were increased. With certain nanofillers, the degradation of optical properties is at least mitigated, while melt processability is preserved. Composites made with preferred nanofillers (e.g., synthetic hectorite) additionally show little or no degradation of optical properties.

### Example U

### Manufacture of Composites and Concentrate Masterbatches Comprising Individual and Mixed Ionomers and Layered Silicate by Melt Extrusion

The configuration and operating conditions used for melt compounding and water injection and removal in Examples P and T were repeated to prepare further ionomer/layered silicate concentrate masterbatches. ION-A and ION-B ionomers and an ION-A/ION-B blend were used as carrier polymers to produce masterbatches with 25 wt. % Laponite® OG synthetic hectorite platy nanofiller on the twin screw extruder. The masterbatches were made in a single pass through the extruder. The extruder used one vacuum zone and had an additional mixing zone installed upstream of the vacuum port to increase the residence time and improve dispersive/distributive mixing performance. The throughput was set to 10 lb/h (4.5 kg/h) and the screw speed was 600 RPM. The deionized water injection flow rate ranged from 31 to 35 mL/min.

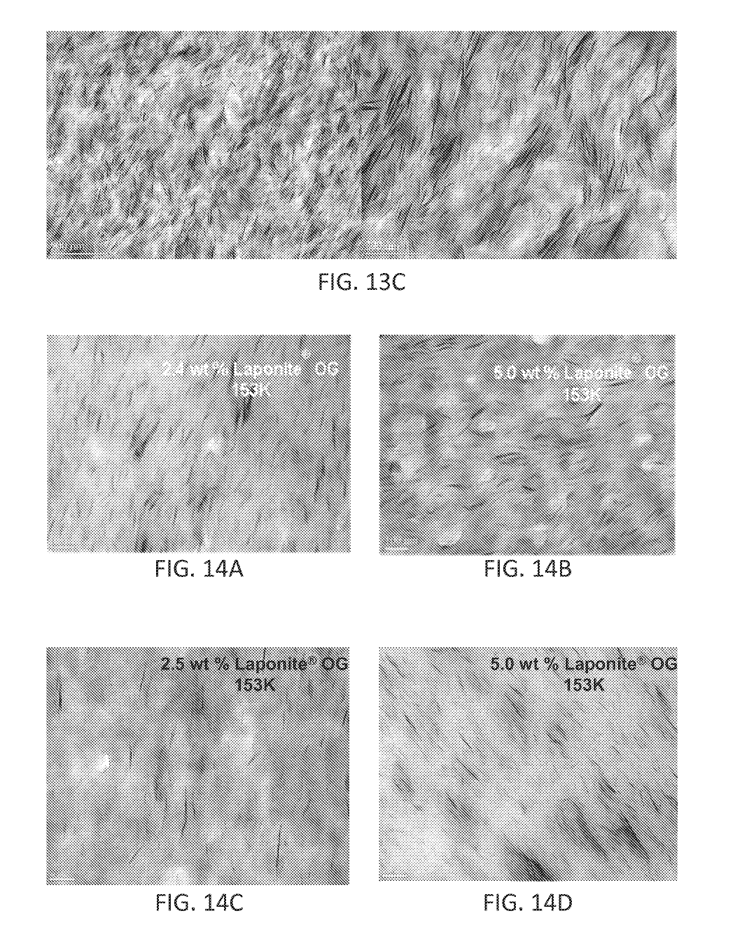

FIGS. 13A-13C show TEM images at two magnifications each of cross-sectioned extruded pellets made respectively with ION-A, ION-B, and a 50/50 wt. % blend of ION-A and ION-B. The ION-B carrier polymer masterbatch (FIG. 13B) had a partially exfoliated structure with tactoids that had greater thickness than those seen using the ION-A sample (FIG. 13A). The blended carrier resulted in a composite microstructure (FIG. 13C) that was more like that of the ION-B sample alone. Thus, the dispersion state of the nanofiller in the present composite can be altered by changing the carrier ionomer resin or by blending two or more water dispersible or water soluble polymers.

### Example V

### Multipolymer Composites Containing Layered Silicate Nanofillers

Multipolymer composite samples were prepared by melt-blending a masterbatch containing a platy silicate nanofiller in a water-dispersible ionomer with a second ionomer. The masterbatches were prepared as dry powders of the compositions of Examples 1, 2, 8, and 9 using the dilute solution processing of Example A. A Brabender PlastiCorder® Model PL2000 mixer with Type 6 mixing head and stainless roller blades was pre-heated to a temperature of 140° C. The respective masterbatches were melt-blended in the mixer with pellets of an ethylene copolymer E/MAA-2, in the quantities indicated in Table XXIII. The materials were mixed at 140° C. for 20 minutes at 75 rpm, under a nitrogen blanket delivered through the ram to provide the material of Examples 45-48.

Upon removal at temperature from the mixer, the blends were clear, but they became hazy at room temperature. TEM images of Examples 45-48, shown respectively in FIGS. 14A-14D, demonstrate that Laponite® OG, which was well-dispersed and well-exfoliated in the composite masterbatch feedstock, remained well-dispersed and well-exfoliated in the melt blended product.

Samples of Examples 45-46 were prepared for optical testing by melt pressing thin films according to the method described in Example B. Optical properties (haze, transmittance, and yellowness index) were measured using the same equipment and protocol described in Example B above. The results reported in Table XXIII show that the optical properties of the melt blends do not differ markedly from those of the starting ionomer ION-A, either in raw pellet form (Comparative Example CE1) or after water processing (Comparative Example CE2), indicating the dispersion and exfoliation in the melt blends remained good enough to prevent signification deterioration in these properties.

TABLE XXIII
Composition and Optical Properties of Melt Blends of
Laponite ® OG/ION-A Composites in E/MAA-2

| | Example | | | |
|---|---|---|---|---|
| | 45 | 46 | 47 | 48 |
| E/MAA-2, g | 32.0 | 32.0 | 32.0 | 32.0 |
| Masterbatch from Example 1, g | 11.0 | — | — | — |
| Masterbatch from Example 2, g | — | 12.0 | — | — |
| Masterbatch from Example 8, g | — | — | 12.0 | — |
| Masterbatch from Example 9, g | | | | 12.0 |
| Ionomer in masterbatch | ION-A | ION-A | ION-B | ION-B |
| Calculated Laponite ® | 9.2% | 18.3% | 9.2% | 18.3% |
| in masterbatch (wt. %) | | | | |
| Calculated Laponite ® | 2.4% | 5.0% | 2.5% | 5.0% |
| in melt blend (wt. %) | | | | |
| Haze (=diffuse/total transmittance) | 1.45% | 2.03% | — | — |
| Total luminous transmittance, | 0.914 | 0.903 | — | — |
| ASTM D1003 | | | | |
| Diffuse luminous transmittance, | 0.013 | 0.018 | — | — |
| ASTM D1003 | | | | |
| Yellowness Index, ASTM E313 | 2.16 | 2.28 | — | — |
| Yellowness Index, ASTM D1925 | 2.10 | 2.26 | — | — |

### Example W

### Preparation and Creep Testing of a Synthetic Hectorite-Filled, Multipolymer Composite

The dilute solution processing method described in Example A was employed to prepare an additional amount of the composition of Example 6, which comprised 18.3 wt. % (calculated) Laponite® OG platy nanofiller in ionomer ION-A, for use as a composite masterbatch. Then, using the melt-blending method of Example V, 12.0 g of this masterbatch was let down in 32.0 g of ION-E ionomer, thereby providing Example 49, containing 5 wt. % (calculated) of Laponite® OG nanofiller. The same melt-blending process was also used to form samples of Comparative Example CE11, comprising 12.0 g of ION-A ionomer and 32.0 g of ION-E ionomer, but without any inclusion of a nanofiller.

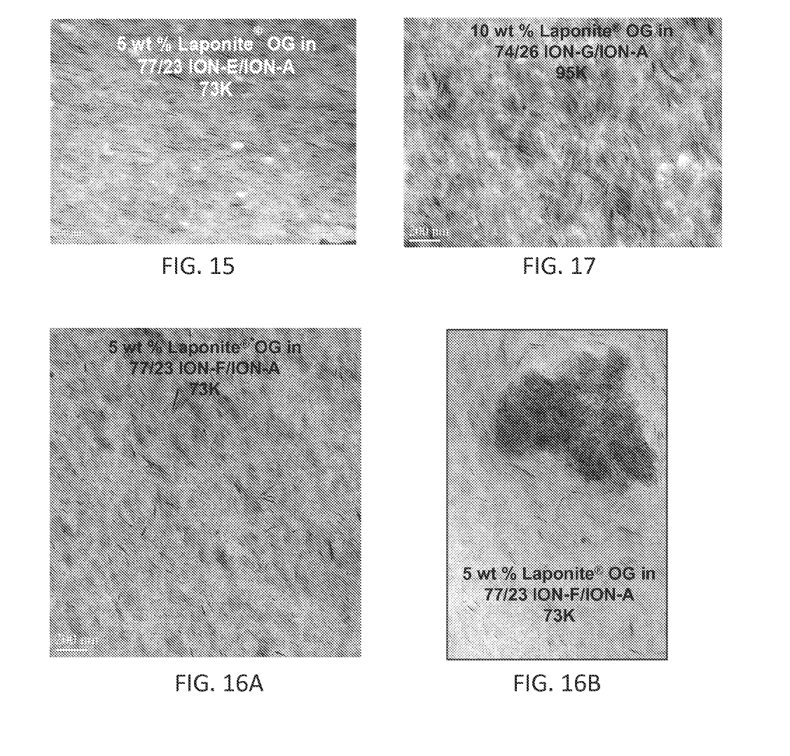

The TEM image in FIG. 15 shows that Laponite® OG platy synthetic hectorite nanofiller, which was well-dispersed and well-exfoliated in the masterbatch, remained well-dispersed and well-exfoliated in the melt-blended, multipolymer letdown product of Example 49.

Films of Comparative Example CE10 (the ION-E ionomer feedstock), Comparative Example CE11, and Example 49 were melt-pressed for creep tests using the methods set forth in Example F above. Comparison of the creep test results given in Table XXIV for these materials show that the nanofiller included in Example 49 imparted enhanced creep resistance at both 40° C. and 65° C.

TABLE XXIV
Isothermal Creep Tests of ION-E/ION-A/Laponite ® OG Composite

| | Example | | |
|---|---|---|---|
| | CE10 | CE11 | 49 |
| | Composition | | |
| | | | 5 wt. % Laponite ® |
| | | 27 wt. % ION-A | OG/24 wt. % ION-A |
| | ION-E | in ION-E | in ION-E |
| 65° C.: | | | |
| % strain @ 0.5 MPa 20 min | 84.0% | 87.6% | 35.3% |
| % strain after 0.5 MPa load & recovery | 34.1% | 35.8% | 15.3% |
| % strain @1 MPa 20 min | stretches out | stretches out | 80.3% |
| % strain after 1 MPa load & recovery | — | — | 30.9% |
| % strain @ 2 MPa 20 min | — | — | stretches out |
| % strain after 2 MPa load & recovery | — | — | — |
| 40° C.: | | | |
| % strain @ 0.5 MPa 20 min | 1.9% | 2.3% | 1.4% |
| % strain after 0.5 MPa load & recovery | 1.2% | 1.5% | 1.0% |
| % strain @1 MPa 20 min | 3.6% | 4.4% | 2.6% |
| % strain after 1 MPa load & recovery | 1.9% | 2.3% | 1.4% |
| % strain @ 2 MPa 20 min | 6.8% | 9.8% | 4.9% |
| % strain after 2 MPa load & recovery | 3.2% | 5.0% | 2.5% |

### Example X

### Preparation and Creep Testing of a Synthetic Hectorite-Filled, Multipolymer Composite

A multipolymer composite comprising Laponite® OG platy synthetic hectorite nanofiller, ION-A ionomer, and ION-F ionomer was prepared by the method generally described in Example W above. In particular, additional masterbatch was prepared using the same materials [18.3 wt. % (calculated) of Laponite® OG platy synthetic hectorite in ionomer ION-A] and protocol described in Example W. Then 12.0 g of this masterbatch was let down in 32.0 g of ION-F ionomer using the Brabender PlastiCorder® Model PL2000 mixer in the same manner as in Example W, yielding the multipolymer composite product of Example 50 with a calculated 5 wt. % Laponite® OG. The TEM images in FIGS. 16A and 16B shows that the Laponite® OG nanofiller, which was well-dispersed and well-exfoliated in the masterbatch, remained well-dispersed and well-exfoliated in the melt-blended product Example 50, with the exception of a few agglomerates apparent in FIG. 16B.

### Example Y

### Preparation and Creep Testing of a Synthetic Hectorite-Filled, Multipolymer Composite

The dilute solution processing method generally described in Example A was used to prepare a masterbatch of the material of Example 3, which comprised 30 wt. % (calculated) Laponite® OG synthetic hectorite platy nanofiller in ION-A ionomer.

The let-down method as described in Examples W and X above was then carried out, with 15.0 g of the foregoing 30 wt. % Laponite® OG/ION-A masterbatch being melt-blended with 30.0 g of ION-G ionomer to provide Example 51. The product was calculated to contain 10 wt. % Laponite® OG nanofiller. Comparative Example CE13 was produced by melt-blending 33 wt. % of material produced in Comparative Example CE2 (water-processed ION-A ionomer) in ION-G ionomer using the same equipment and protocol.

The TEM image in FIG. 17 shows that Laponite® OG synthetic hectorite, which was well-dispersed and well-exfoliated in the composite masterbatch, remained well-dispersed and well-exfoliated in the melt-blended Example 51 multipolymer composite.

Thin films were prepared and creep-tested using the methods described in Example F. The results given in Table XXV compare data for Example 51 and for Comparative Examples CE12 and CE13, respectively prepared with pure ION-G ionomer feedstock and a melt blend of 33 wt. % of material produced in Comparative Example CE2 (water-processed ION-A) and ionomer ION-G feedstock, both without any nanofiller. The data show that inclusion of the nanofiller improves the creep resistance of both the unfilled ION-G material and the water-processed ION-A/ION-G melt blend. Table XXV also includes DMA data for Example 51, showing enhancement of storage and loss moduli at 25° C. and 95° C. are higher compared with those of the ION-G ionomer feedstock (CE12) and the blended material (CE13).

TABLE XXV
Creep and DMA Results for Multipolymer
ION-A/ION-G/Synthetic Hectorite Composites

| | Example | | |
|---|---|---|---|
| | CE12 | CE13 | 51 |
| | Composition | | |
| | | 33 wt. % water- | |
| | | processed | 10 wt. % Laponite ® |
| | ION-G | ION-A, let | OG/26 wt. % ION-A |
| | feedstock | down in ION-G | in ION-G |
| 65° C.: | | | |
| %strain @ 0.5 MPa 20 min | 60.7% | 60.9% | 16.6% |
| % strain after 0.5 MPa load & recovery | 22.2% | 22.4% | 7.5% |
| % strain @1 MPa 20 min | 139.0% | 130.7% | 29.8% |
| % strain after 1 MPa load & recovery | 39.6% | 38.3% | 11.3% |
| % strain @ 2 MPa 20 min | stretches out | stretches out | 74.1% |
| % strain after 2 MPa load & recovery | — | — | 23.6% |
| 40° C.: | | | |
| % strain @ 0.5 MPa 20 min | 4.0% | 2.3% | 1.1% |
| % strain after 0.5 MPa load & recovery | 2.1% | 1.5% | 0.8% |
| % strain @1 MPa 20 min | 8.7% | 5.2% | 2.2% |
| % strain after 1 MPa load & recovery | 3.8% | 2.6% | 1.2% |
| % strain @ 2 MPa 20 min | 18.8% | 11.2% | 4.3% |
| % strain after 2 MPa load & recovery | 7.2% | 4.8% | 2.0% |
| 25° C.: | | | |
| Storage modulus, MPa | 633 | 633 | 1215 |
| Loss modulus, MPa | 38.3 | 26.3 | 33.5 |
| 95° C.: | | | |
| Storage modulus, MPa | 1.5 | 1.8 | 4.5 |
| Loss modulus, MPa | 0.6 | 0.7 | 1.8 |

### Example Z

### Preparation and Creep and Scratch Testing of a Colloidal Silica-Filled, Multipolymer Composite

The dilute solution processing technique generally described in Example K was used to prepare a masterbatch comprising ION-A ionomer and 30 wt. % colloidal silica nanofiller dispersed therein. The colloidal silica was supplied from Ludox® TMA aqueous dispersion, which was first diluted with deionized water from the as-received 34 wt. % colloidal silica concentration to 10 wt. %. For each batch, 70.0 g of the diluted dispersion was combined with a solution of 16.35 g of ION-A in 133.65 g of deionized water, The material was then dried as described in Example K.

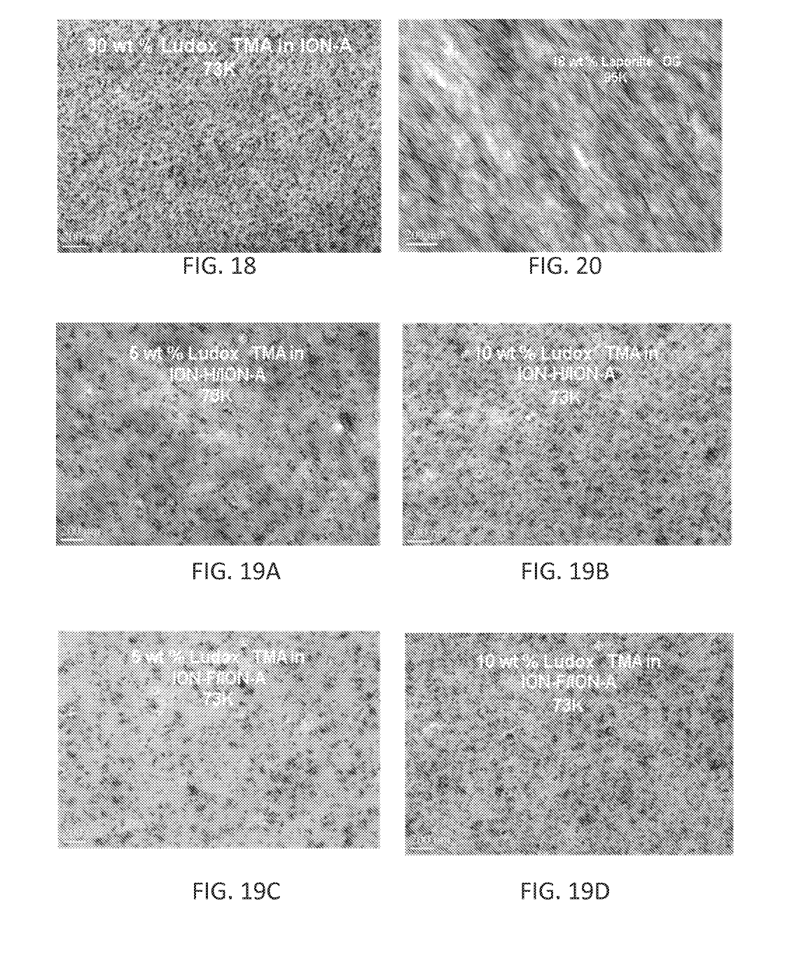

A TEM image of the masterbatch material is shown in FIG. 18, demonstrating excellent dispersion of the colloidal silica in the ionomer.

This masterbatch was then let down in ION-F and ION-H ionomers using the Brabender PlastiCorder® Model PL2000 mixer and the techniques of Examples W-Y. The materials were mixed at 140° C. for 20 minutes at 75 rpm, under a nitrogen blanket delivered through the ram. Samples were made with 5 and 10 wt. % final silica concentration in each of the two let-down polymers, thereby forming Examples 52-55 shown in Table XXVI. Comparative Examples CE14 and CE15 were prepared using the same let-down technique to incorporate ION-A without any nanofiller in ION-F and ION-H ionomers, respectively.

TABLE XXVI
Melt blends of colloidal silica/ionomer ION-A composites
in ionomers ION-F and ION-H

| | Example | | | | | |
|---|---|---|---|---|---|---|
| | CE14 | 52 | 53 | CE15 | 54 | 55 |
| ION-A ionomer | 11.7 | — | — | 11.7 | — | — |
| ION-A/colloidal silica | — | 7.5 | 15.0 | — | 7.5 | 15.0 |
| masterbatch, g | | | | | | |
| ION-H ionomer, g | 33.3 | 37.5 | 30.0 | — | — | — |
| ION-F ionomer, g | — | — | — | 33.3 | 37.5 | 30.0 |
| Calculated wt. % silica in | — | 5% | 10% | — | 5% | 10% |
| blended composite | | | | | | |
| Calculated wt. % ION-A in | 26% | 12% | 26% | 26% | 12% | 26% |
| combined polymers | | | | | | |

FIGS. 19A-19D show TEM images of the material of Examples 52-55, respectively, demonstrating that colloidal silica, which was well-dispersed in the composite masterbatch, remained well-dispersed in the melt blends.

The products of Examples 52-55 were melt-pressed into 1 mm-thick plaques for measurement of scratch resistance, which was carried out in accordance with ISO method 1518-1 using a 1-mm diameter stylus and an Erichsen 239/II, EP 2278 scratch tester. For each test, the stylus was moved across the plaque under a specified load at ambient temperature. The initial load was 2 N, and the test was repeated with the load incremented by 2 N on each cycle, up to a final load of 20 N. The load at which a scratch first became visible to the naked eye was recorded. After each cycle, the severity of the scratch, if any, was recorded on a 0 to 4 scale, with 0 representing no scratch and 4 representing a strong scratch. For comparison, plaques were also melt-pressed from the ionomer feedstocks of ION-H (Comparative Example CE14A) and ION-F (Comparative Example CE15A)

For each sample, the severity ratings for the scratches at all loads from 2N to 20N were summed and recorded. A low value for the foregoing sum and a high value for the load required for the initial scratch are taken to indicate good scratch resistance. The results given in Table XXVII show that the scratch resistance of both the ION-F and ION-H ionomer feedstocks was improved somewhat by the addition of the ION-A ionomer, but further improved by the incorporation of colloidal silica carried by the ION-A ionomer.

TABLE XXVII
Scratch-resistance of ionomers, multipolymer melt blends,
and multipolymer composites with colloidal silica nanofiller.

| | | Load at which | Sum of scratch |
|---|---|---|---|
| | Calculated | scratch is first | magnitude |
| | wt. % silica | visible | ratings |
| ION-H ionomer (CE14A) | — | 8 | 14 |
| Comparative Example | — | 10 | 10 |
| CE14 | | | |
| Example 52 | 5% | 10 | 10 |
| Example 53 | 10% | 12 | 5 |
| ION-F ionomer (CE15A) | — | 12 | 8 |
| Comparative Example | — | 16 | 4 |
| CE15 | | | |
| Example 54 | 5% | 16 | 4 |
| Example 55 | 10% | 16 | 3 |

### Example AA

### Preparation and Testing of Multipolymer Composites Comprising Synthetic Hectorite, Ionomer, and Polyamide

A multipolymer composite comprising Laponite® OG platy synthetic hectorite nanofiller, ION-A ionomer, and nylon 66 polyamide was prepared using the method generally described in Example W above.

The dilute solution processing method described in Example G was used to prepare a masterbatch using a mixed aqueous solvent. The ingredients were 123.8 g of deionized water, 41.2 g of isopropanol, 22.05 g of ION-A ionomer, and 4.95 g of Laponite® OG platy synthetic hectorite. The TEM image in FIG. 20 shows excellent dispersion and exfoliation of the Laponite® OG nanofiller in the resulting dry powder masterbatch.

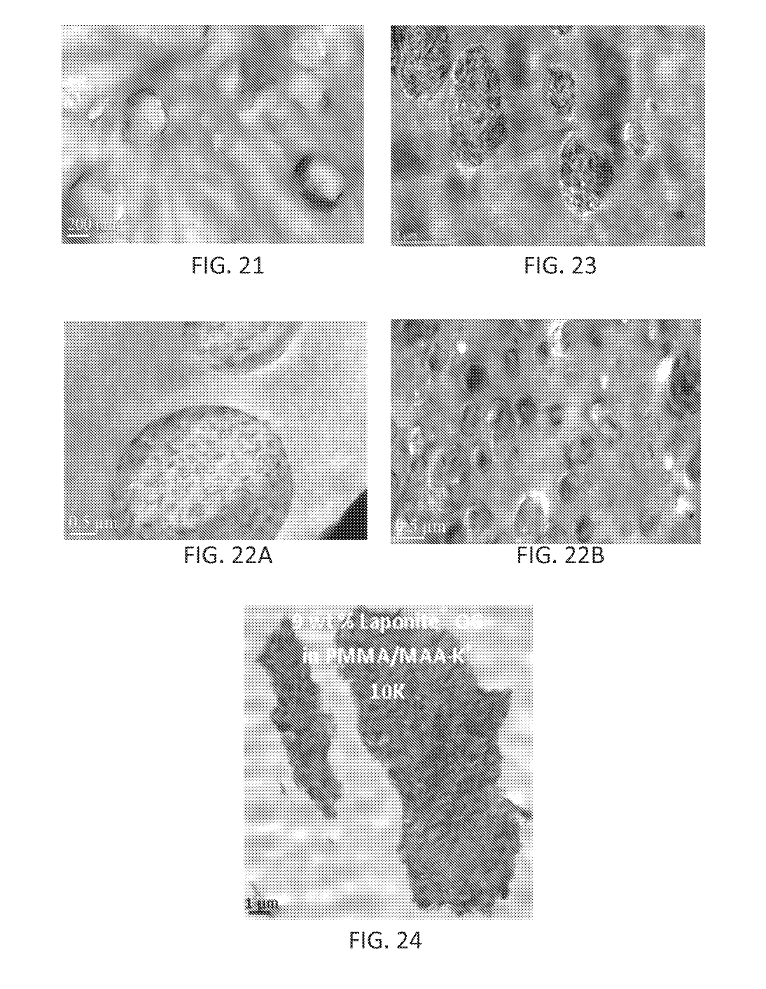

This masterbatch was then let down into nylon 66 using a melt blending operation carried out in a Brabender PlastiCorder® Model PL2000 mixer, as described generally in Examples W-Y above. The mixing head and stainless roller blades were heated to 285° C. and charged under a nitrogen blanket with 40.0 g of Zytel® 101 nylon 66 at 30 rpm speed. After the nylon melted, the speed was raised to 75 rpm and 0.3 g of Irganox® 1098 antioxidant was added, followed by 10.0 g of the 18 wt. % Laponite® OG masterbatch. The mixing was continued for 10 min at 75 rpm. Portions of the melt were then removed as quickly and safely as possible, by immediately dropping each into about 1 L of deionized water in a metal beaker to prevent the nylon in the melt from oxidizing on its surface. The TEM image in FIG. 21 shows approximately 300-nm spherical domains of ION-A ionomer in the nylon, with the Laponite® nanofiller remaining in the ION-A phase, but tending to accumulate at the interface with the nylon.

### Example AB

### Preparation and Testing of Multipolymer Composites Comprising Synthetic Hectorite, Ionomer, and Ethylene Copolymer

Multipolymer composites were prepared by letting down masterbatches comprising different concentrations of Laponite® OG platy synthetic hectorite in ionomer ION-A into E/MA-1 ethylene/methyl acrylate copolymer. Masterbatches were prepared as dry powders having the compositions of Examples 4 and 6 above. The let-down was accomplished using a Brabender PlastiCorder® Model PL2000 mixer with Type 6 mixing head and stainless roller blades heated to 150° C., using the techniques described generally in the previous examples V-Y. Examples 56 and 57 were prepared by melt blending a masterbatch of Example 4 or 6, respectively, with E/MA-1, in the quantities indicated in Table XXVII. The same melt-blending process was also used to form samples of Comparative Example CE17, comprising ION-A ionomer and E/MA-1 in the quantities indicated in Table XXVIII, but without any inclusion of a nanofiller. Films for Comparative Example CE16 were pressed from E/MA-1 feedstock.

The materials were mixed at 150° C. for 20 minutes at 75 rpm, under a nitrogen blanket delivered through the ram.

TEM images of samples of Examples 57 and 57 (FIGS. 22A and 22B, respectively) show that the ION-A ionomer was dispersed in the ethylene/methyl acrylate copolymer as droplets of several microns in diameter for Example 56 and about 0.5 micron diameter for Example 57. The Laponite® nanofiller remained in the ION-A phase in an at least partly exfoliated state.

Table XXVIII further includes creep-resistance results taken on melt-pressed film samples prepared and tested in accordance with the methods described in Example F above. The data show that ION-A reduces the creep strain of the ethylene/methyl acrylate copolymer E/MA-1 at 40° C. under 0.5 MPa and 1.0 MPa loads and that the incorporation of Laponite® OG nanofiller in ION-A further reduces the creep strain.

TABLE XXVIII
Melt blends of Laponite ® OG/lonomer composites in E/MA

| | Example | | | |
|---|---|---|---|---|
| | CE16 | CE17 | 56 | 57 |
| E/MA-1 ethylene/methyl acrylate | — | 32.0 | 29.9 | 32.0 |
| copolymer, g | | | | |
| ION-A ionomer, g | — | 10.9 | — | — |
| Composite from Example 4, g | — | | 11.2 | — |
| Composite from Example 6, g | — | — | — | 12.0 |
| Calculated Laponite ® in composite | — | 0% | 2.5% | 5.0% |
| (wt. %) | | | | |
| Calculated ION-A in multipolymer | — | 25% | 25% | 23% |
| melt blend (wt. %) | | | | |
| Creep test at 40° C. | | | | |
| (average of 2 tests) | | | | |
| % strain @ 0.5 MPa for 20 min | 6.7% | 3.5% | 3.2% | 2.9% |
| % strain after 0.5 MPa load and | 1.1% | 0.8% | 0.8% | 0.7% |
| 30 min recovery | | | | |
| % strain @ 1 MPa for 20 min | 18.8% | 8.6% | 7.0% | 6.7% |
| % strain after 1 MPa load and | 2.6% | 1.4% | 1.1% | 1.2% |
| 30 min recovery | | | | |

### Example AC

### Preparation and Testing of Multipolymer Composites Comprising Synthetic Hectorite and Multiple Ionomers

Production and testing of melt-miscible, multiple polymer composites made from melt-extruded masterbatch concentrates comprising water-dispersible ionomer and hydrophilic nanoparticles that are subsequently combined with further water-dispersible ionomer in a melt extrusion letdown step.

The melt compounding and water injection and removal configuration described in Examples P and T was used to prepare masterbatches containing ION-A or ION-B as the carrier polymer with 20 wt. % Cloisite® Na⁺ MMT or Laponite® OG synthetic hectorite nanofillers. A first set of the masterbatches was made in a single pass through the extruder (“1-pass”). In order to alter the extent of exfoliation and effective aspect ratio of the layered silicates, a second set of masterbatches was processed using two passes through the extruder. In the first pass, the ionomer and filler were combined by passing them through the extruder using the same conditions and materials as before. Then the extruded pellets were passed through a second time with water injection and removal, creating material denoted as “2-pass.” Water injection and removal, as described in Example P, was used in both passes.

A melt compounding process was then used to produce melt-miscible, multipolymer composites. The same ZSK-18 mm intermeshing, co-rotating twin-screw extruder (Coperion Corp.) configuration used initially to prepare the masterbatches was subsequently used to melt blend the respective masterbatches and additional ionomer. Pellets of the host (matrix) polymer and the masterbatch were metered into the extruder separately using loss-in-weight-feeders (KTron Corp.) or were pre-mixed as a dry pellet blend and then metered with one feeder. No attempt was made to exclude oxygen from the extruder. For these samples, barrel temperatures were profiled in a range from 175 to 200° C. depending on heat transfer and thermal requirements for melting, mixing and extrusion through the die. The throughput was fixed at 10 lb/h (4.5 kg/h) and the screw rotational speed was 350 RPM. No organic surface modifiers were employed in the masterbatch production or added during the melt compounding extrusion process.

For each of the Examples 58-65 listed in Table XXIX, the melt compounding was done by adding the same ionomer used in the respective masterbatch in an amount calculated to produce a layered silicate concentration of 5 wt. % in the final blended product.

TABLE XXIX
Ionomer Composites Comprising Water-Dispersible Ionomers and Platy Nanofillers

| | | | | Letdown | | | Strain @ | | |
|---|---|---|---|---|---|---|---|---|---|
| Ex. | Carrier | | Masterbatch | Matrix | E | YS | Break | | |
| No. | Polymer | Filler | Processing | Polymer | (MPa) | (MPa) | (% elong.) | E/E₀ | MFR |
| CE18 | ION-A | — | feedstock | — | 515.1 | 22.8 | 76.5 | 1.00 | 5.60 |
| 58 | ION-A | Cloisite ® Na⁺ MMT, | 1-pass | ION-A | 622.8 | 23.6 | 111.7 | 1.21 | |
| 59 | ION-A | Cloisite ® Na⁺ MMT, | 2-pass | ION-A | 631.6 | 24.1 | 104.6 | 1.23 | |
| 60 | ION-A | Laponite ® OG hectorite | 1-pass | ION-A | 643.5 | 24.5 | 80.1 | 1.25 | 2.85 |
| 61 | ION-A | Laponite ® OG hectorite | 2-pass | ION-A | 648.5 | 24.7 | 74.7 | 1.26 | 2.68 |
| CE19 | ION-B | — | feedstock | | 457.5 | 22.4 | 45.8 | 1.00 | |
| 62 | ION-B | Cloisite ® Na⁺ MMT, | 1-pass | ION-B | 579.0 | 27.4 | 107.5 | 1.42 | |
| 63 | ION-B | Cloisite ® Na⁺ MMT, | 2-pass | ION-B | 593.5 | 20.1 | 63.5 | 1.45 | |
| 64 | ION-B | Laponite ® OG hectorite | 1-pass | ION-B | 602.1 | 24.7 | 55.2 | 1.47 | |
| 65 | ION-B | Laponite ® OG hectorite | 2-pass | ION-B | 595.4 | 19.8 | 40.8 | 1.46 | |

Extruded pellet samples of the melt-blended, multipolymer composites were dried and injection molded into ASTM tensile bars and tested using the same procedures described in Example P. For Comparative Examples CE18 and CE19, ION-A and ION-B feedstock pellets without any nanofiller were directly injection-molded. All compositions could be injection molded or made into films using conventional melt processing equipment operating under conditions recommended for commercial ionomer resins. Tensile bars exhibited no defects (flash, sink marks, flow marks, and the like) that could be induced by significant increases in melt viscosity or by excessive levels of moisture, entrapped air, or other volatile gases.

As seen in the mechanical test data in Table XXIX, Young's modulus increased with the addition of MMT and synthetic hectorite. There was no significant difference in the modulus in samples made from the 1-pass or 2-pass masterbatches. The yield stress increased slightly with the addition of MMT and synthetic hectorite in the ION-A system. For the ION-B composites, yield stress increased with materials using the 1-pass masterbatches, while there was a slight decrease for those samples using 2-pass masterbatches.

MFR measurements were made on selected samples using the procedure described in Example S. From Table XXIX, the MFR of the ION-A composites containing 5 wt. % Laponite® OG let down from both 1-pass and 2-pass masterbatches decreased from 5.60 to 2.85 and 2.68 g/10 min, respectively. The MFR reductions showed that the composites made by the masterbatch followed by letdown method preserved processability for subsequent shaping and forming operations. The elongation at break was increased slightly for the samples containing MMT and remained effectively unchanged for the synthetic hectorite composites.

Optical properties were also measured using the methods described in Example P. The data in Table XXX show that tensile bar samples containing synthetic hectorite all matched the unfilled controls, as they had no appreciable haze or color within the ranking levels of the semi-quantitative system delineated in Example P, but the tensile bar samples containing MMT all had significant levels of haze and color. Compression-molded film samples 0.25 mm thick were made and colorimetrically tested using the procedure described in Invention Example P. In the ION-B system, the percent haze increased slightly, the WI decreased slightly and the YI increased slightly. Haze was reduced and WI and YI had slight changes with the 2-pass masterbatch material. In the ION-A system using the 1-pass masterbatch material, the percent haze increased slightly, the WI decreased slightly, and the YI increased slightly. Haze was reduced, the WI dropped slightly, and YI increased slightly with the 2-pass masterbatch material.

TABLE XXX
Optical properties of Ionomer Composites Comprising
Water-Dispersible Ionomers and Platy Nanofillers

| | | | Haze | WI | YI | YI |
|---|---|---|---|---|---|---|
| Ex. | Color | Haze | ASTM | ASTM | ASTM | ASTM |
| No. | Code | Code | D1003 | E313 | E313 | D1925 |
| CE18 | 0 | 0 | 3.18 | 84.42 | 2.04 | 1.92 |
| CE19 | 0 | 0 | 1.11 | 85.05 | 1.92 | 1.76 |
| 58 | 3 | 3 | | | | |
| 59 | 3 | 3 | | | | |
| 60 | 0 | 0 | 3.30 | 83.53 | 2.15 | 2.06 |
| 61 | 0 | 0 | 2.46 | 82.93 | 2.32 | 2.27 |
| 62 | 3 | 3 | | | | |
| 63 | 3 | 3 | | | | |
| 64 | 0 | 0 | 2.70 | 82.87 | 2.30 | 2.25 |
| 65 | 0 | 0 | 2.46 | 83.09 | 2.27 | 2.20 |

### Example AD

### Preparation and Testing of Multipolymer Composites Comprising Synthetic Hectorite and Multiple Ionomers

The methods used to prepare and let down ionomer batches described in Example AC were repeated using another host ionomer (ION-C). The 20 wt. % MMT and synthetic hectorite, 1-pass and 2-pass ionomer masterbatches were all let down into ION-C ionomer to form Examples 66-73 of Table XXXI, with a final calculated concentration of 5 wt. % of the layered silicate. Comparative Example CE20 was prepared directly from ION-C ionomer. Polymer blend control samples (Comparative Examples CE21 and CE22) were made containing 20 wt. % of the respective ionomer carrier resins in the ION-C host polymer, but without any nanofiller. For the polymer blend controls, Young's modulus and yield stress increased slightly, while the elongation at break did not change significantly. The Young's modulus was increased by approximately 30% and yield stress increased slightly with the addition of MMT or synthetic hectorite. There was less than approximately a 5% change in modulus in samples made with the 1-pass or 2-pass masterbatches. The elongation at break was not changed appreciably with MMT or synthetic hectorite addition.

MFR measurements were made on selected ones of these samples using the procedure described in Example S. Table XXXI shows that the MFR of the ION-C ionomer composites containing 5 wt. % synthetic hectorite let down from both 1-pass and 2-pass masterbatches decreased from 5.20 to between 2.30 and 2.79 g/10 min, respectively. The MFR reductions showed that the composites made by the masterbatch followed by letdown into a sodium ionomer preserved processability for subsequent shaping and forming operations.

TABLE XXXI
Ionomer Composites Comprising Ionomers and Platy Nanofillers

| | | | | | | Strain @ | | |
|---|---|---|---|---|---|---|---|---|
| Ex. | Carrier | | Masterbatch | E | YS | Break | | |
| No. | Polymer | Filler | Processing | (MPa) | (MPa) | (% elong.) | E/E₀ | MFR |
| CE20 | — | — | * | 408.3 | 18.5 | 115.6 | 1.00 | 5.20 |
| CE21 | ION-A | — | ** | 427.9 | 20.3 | 106.1 | 1.05 | |
| 66 | ION-A | Cloisite ® Na⁺ MMT, | 1-pass | 535.5 | 21.4 | 103.2 | 1.31 | |
| 67 | ION-A | Cloisite ® Na⁺ MMT, | 2-pass | 524.8 | 21.2 | 108.0 | 1.29 | |
| 68 | ION-A | Laponite ® OG hectorite | 1-pass | 560.3 | 22.8 | 96.3 | 1.37 | 2.79 |
| 69 | ION-A | Laponite ® OG hectorite | 2-pass | 545.8 | 22.4 | 100.4 | 1.34 | 2.77 |
| CE22 | ION-B | — | *** | 426.8 | 19.7 | 90.0 | 1.05 | |
| 70 | ION-B | Cloisite ® Na⁺ MMT, | 1-pass | 539.2 | 21.5 | 103.9 | 1.32 | |
| 71 | ION-B | Cloisite ® Na⁺ MMT, | 2-pass | 555.2 | 22.0 | 101.2 | 1.36 | |
| 72 | ION-B | Laponite ® OG hectorite | 1-pass | 532.0 | 21.5 | 89.6 | 1.30 | 2.41 |
| 73 | ION-B | Laponite ® OG hectorite | 2-pass | 545.9 | 21.6 | 82.0 | 1.34 | 2.30 |

* ION-C feedstock
** 80 ION-C/20 ION-A
*** 80 ION-C/20 ION-B

Table XXXII reports optical data for Examples 66-73 and Comparative Examples CE20-CE23. None of the tensile bars containing synthetic hectorite had any appreciable haze or color within the semi-quantitative ranking levels described in Example P, but all the tensile bar samples containing MMT did have significant levels of haze and color in this characterization. Quantitative colorimetric testing was carried out on selected samples that were compression-molded as 0.25 mm thick films as described in Examples B-E. Compared with the ION-C ionomer feedstock, the polymer blend controls and the compounding melt history had a minor impact on color as measured by WI and YI. Haze was reduced slightly with the addition of ION-A, while it increased with the addition of ION-B. For the synthetic hectorite composites, haze, WI and YI increased slightly. For the letdowns in ION-C incorporating ION-A as the carrier polymer, haze was decreased in the ionomer composites made using the 2-pass masterbatch material as compared with the 1-pass material.

TABLE XXXII
Optical properties of Ionomer Composites Comprising
Ionomers and Platy Nanofillers

| | | | Haze | WI | YI | YI |
|---|---|---|---|---|---|---|
| Ex. | Color | Haze | ASTM | ASTM | ASTM | ASTM |
| No. | Code | Code | D1003 | E313 | E313 | D1925 |
| CE20 | 0 | 0 | 1.68 | 85.09 | 1.90 | 1.75 |
| CE21 | 0 | 0 | 1.36 | 84.83 | 1.94 | 1.79 |
| CE22 | 0 | 0 | 2.30 | 84.66 | 1.96 | 1.81 |
| 66 | 3 | 4 | | | | |
| 67 | 3 | 3 | | | | |
| 68 | 0 | 0 | 3.88 | 83.54 | 2.15 | 2.06 |
| 69 | 0 | 0 | 2.93 | 83.24 | 2.23 | 2.17 |
| 70 | 3 | 3 | | | | |
| 71 | 3 | 3 | | | | |
| 72 | 0 | 0 | 2.23 | 83.22 | 2.22 | 2.17 |
| 73 | 0 | 0 | | | | |

### Example AE

### Preparation and Testing of Multipolymer Composites Comprising Synthetic Hectorite and Multiple Ionomers

The experiments carried out in Example AD were repeated with the same masterbatches but with a Zn ionomer, ION-D, as the host for the let-down melt blending step. Comparable experiments were carried out by letting down the same ionomer/20 wt. % layered silicate masterbatch concentrates made by the 1-pass and 2-pass methods into a zinc ionomer ION-D using a conventional melt blending process on a ZSK-18 mm twin-screw extruder. Table XXXIII lists compositions of composites prepared from the letdown of 1-pass and 2-pass ionomer concentrates containing 20 wt. % MMT and synthetic hectorite into ION-D to attain a concentration of 5 wt. % (calculated) of the layered silicate in each of Examples 74-81. Samples for Comparative Example CE23 were made directly from the ION-D feedstock. Polymer blend control samples (Comparative Examples CE24 and CE25) were made by melt compounding 20 wt. % of the ION-A or ION-B carrier resins with ION-D host resin using a similar extrusion process. For these polymer blend controls, the Young's modulus increased by approximately 40% and the yield stress increased slightly, while the elongation at break did not change significantly. The Young's modulus was increased by approximately 70 to 80% and yield stress was preserved or increased slightly with the addition of the MMT or synthetic hectorite masterbatches. There was less than approximately a 5% change in modulus in samples made from the 1-pass or 2-pass masterbatch methods. The elongation at break was approximately the same or slightly reduced with MMT or synthetic hectorite masterbatch addition.

MFR measurements were made on selected samples using the procedure described in Example S. From Table XXXIII, the MFR of the zinc ionomer (ION-D) composites containing 5 wt. % synthetic hectorite let down from both 1-pass and 2-pass masterbatches decreased from 3.56 to between 2.29 and 2.83 g/10 min, respectively. The small MFR reductions showed that the composites made by the masterbatch followed by letdown into a zinc ionomer preserved processability for subsequent shaping and forming operations.

TABLE XXXIII
Ionomer Composites Comprising Ionomers and Platy Nanofillers

| | | | | | | Strain @ | | |
|---|---|---|---|---|---|---|---|---|
| Ex. | Carrier | | Masterbatch | E | YS | Break | | |
| No. | Polymer | Filler | Processing | (MPa) | (MPa) | (% elong.) | E/E₀ | MFR |
| CE23 | — | — | * | 309.4 | 19.2 | 99.6 | 1.00 | 3.56 |
| CE24 | ION-A | — | ** | 434.0 | 19.8 | 92.9 | 1.40 | |
| 74 | ION-A | Cloisite ® Na⁺ MMT | 1-pass | 541.3 | 21.7 | 104.7 | 1.75 | |
| 75 | ION-A | Cloisite ® Na⁺ MMT | 2-pass | 523.1 | 20.9 | 102.5 | 1.69 | |
| 76 | ION-A | Laponite ® OG hectorite | 1-pass | 553.4 | 22.1 | 83.3 | 1.79 | 2.83 |
| 77 | ION-A | Laponite ® OG hectorite | 2-pass | 547.5 | 22.0 | 81.6 | 1.77 | 2.76 |
| CE25 | ION-B | | *** | 442.5 | 20.4 | 85.7 | 1.43 | |
| 78 | ION-B | Cloisite ® Na⁺ MMT, | 1-pass | 555.2 | 22.4 | 93.5 | 1.79 | |
| 79 | ION-B | Cloisite ® Na⁺ MMT, | 2-pass | 561.5 | 19.3 | 59.5 | 1.81 | |
| 80 | ION-B | Laponite ® OG hectorite | 1-pass | 550.6 | 21.8 | 73.6 | 1.78 | 2.43 |
| 81 | ION-B | Laponite ® OG hectorite | 2-pass | 551.0 | 22.3 | 77.8 | 1.78 | 2.29 |

* ION-D feedstock
** 80 ION-D/20 ION-A
*** 80 ION-D/20 ION-B

Optical measurements made on these samples are set forth in Table XXXIV. Using the semi-quantitative haze and color evaluation method of Example P, all tensile bar samples containing MMT had significant levels of haze and color. Compared to the unfilled controls, all tensile bars containing synthetic hectorite had no appreciable haze or color within the ranking levels. Film samples with 0.25 mm thickness were made using the compression molding procedure described in Examples B-E. Comparison of the zinc ionomer feedstock (ION-D, CE23) and the polymer blend controls (CE24 and CE25) shows that the compounding melt history experienced by the polymers had a minor impact on color as measured by WI and YI. Haze was reduced slightly with the addition of ION-A or ION-B ionomers in the polymer blend control samples. For the synthetic hectorite composites, haze decreased slightly as compared to the unfilled zinc ionomer. For the letdowns using the ION-A carrier polymer, haze was decreased in the zinc ionomer composites made using the 2-pass masterbatch material as compared with the 1-pass material.

TABLE XXXIV
Physical and Optical Properties of Ionomer Composites
Comprising Ionomers and Platy Nanofillers

| | | | | Haze | WI | YI | YI |
|---|---|---|---|---|---|---|---|
| | | Color | Haze | ASTM | ASTM | ASTM | ASTM |
| Ex. No. | Polymer/Filler | Code | Code | D1003 | E313 | E313 | D1925 |
| CE23 | * | 0 | 0 | 4.41 | 83.62 | 2.12 | 2.02 |
| CE24 | ** | 0 | 0 | 1.98 | 84.49 | 2.01 | 1.88 |
| 74 | Cloisite ® Na⁺ MMT/1-pass | 3 | 3 | | | | |
| 75 | Cloisite ® Na⁺ MMT/2-pass | 3 | 3 | | | | |
| 76 | Laponite ® OG hectorite/1-pass | 0 | 0 | 4.33 | 83.15 | 2.23 | 2.15 |
| 77 | Laponite ® OG hectorite/2-pass | 0 | 0 | 3.05 | 83.71 | 2.15 | 2.05 |
| CE25 | *** | 0 | 0 | 3.46 | 83.56 | 2.19 | 2.09 |
| 78 | Cloisite ® Na⁺ MMT/1-pass | 3 | 3 | | | | |
| 79 | Cloisite ® Na⁺ MMT/2-pass | 3 | 3 | | | | |
| 80 | Laponite ® OG hectorite/1-pass | 0 | 0 | 2.45 | 82.96 | 2.31 | 2.25 |
| 81 | Laponite ® OG hectorite/2-pass | 0.5 | 0 | 4.14 | 81.50 | 2.60 | 2.59 |

* ION-D feedstock
** 80 ION-D/20 ION-A
*** 80 ION-D/20 ION-B

Examples AC-AE demonstrate that water-dispersible and unmodified, hydrophilic layered silicates can be dispersed effectively using a melt compounding process that optionally incorporates water injection and removal to produce masterbatch concentrates that can be let down in a melt-miscible matrix (host) polymer using a second melt compounding step, with the nanofiller remaining at least partially exfoliated. The resulting multipolymer composites include, in various embodiments, materials that exhibit useful mechanical and/or optical properties. Embodiments of such composites include ones in which the clarity and color of the original constituent polymers are retained, while mechanical properties such as Young's modulus and yield strength are enhanced.

### Example AF

### Preparation and Testing of Multipolymer Composites Comprising Platy Silicate Nanofiller, Water-Dispersible Ionomer, and Immiscible Host Polymer

The techniques described in Examples AC-AE were used first to prepare masterbatches containing 20 wt. % Cloisite® Na⁺ MMT or Laponite® OG synthetic hectorite and then to let the masterbatches down in an immiscible Linear Low Density Polyethylene host polymer (LLDPE). Both the masterbatch preparation and letdown step were carried out in the same ZSK-18 mm intermeshing, co-rotating twin-screw extruder configuration that was operated under similar conditions as before. The barrel temperatures were profiled in a range from 175 to 200° C. depending on heat transfer and thermal requirements for melting, mixing and extrusion through the die. The screw rotational speed was 350 RPM and the throughput was fixed at 10 lb/h (4.5 kg/h). The proportions of the masterbatch and host polymer were set to provide a layered silicate concentration of 5 wt. %. No organic surface modifiers were used or were added to the extrusion process. The samples produced are listed in Table XXXV. Also listed are Comparative Examples CE26 and CE27, respectively prepared using the LLPDE feedstock before and after extrusion, and Comparative Examples CE28 and CE29, prepared by extruding a blend of LLPDE and 20 wt. % of ionomers ION-A and ION-B.

TABLE XXXV
Composition and Tensile Properties of Immiscible Multipolymer
Composites Comprising Ionomers and Platy Nanofillers

| | | | | | | Strain @ | | | |
|---|---|---|---|---|---|---|---|---|---|
| Ex. | Carrier | | Masterbatch | E | YS | Break | | YS/ | E@B/ |
| No. | Polymer | Filler | Processing | (MPa) | (MPa) | (% elong.) | E/E₀ | YS₀ | E@B₀ |
| CE26 | — | — | * | 145.0 | 11.1 | 85.8 | 1.00 | 1.00 | 1.00 |
| CE27 | — | — | ** | 147.1 | 12.9 | 90.8 | 1.01 | 1.17 | 1.06 |
| CE28 | ION-A | — | *** | 209.1 | 13.8 | 80.9 | 1.42 | 1.24 | 0.94 |
| 82 | ION-A | Cloisite ® Na⁺ MMT, | 1-pass | 295.5 | 16.4 | 63.2 | 2.01 | 1.48 | 0.74 |
| 83 | ION-A | Cloisite ® Na⁺ MMT, | 2-pass | 287.1 | 16.6 | 69.5 | 1.95 | 1.50 | 0.81 |
| 84 | ION-A | Laponite ® OG hectorite | 1-pass | 295.4 | 16.4 | 68.4 | 2.01 | 1.48 | 0.80 |
| 85 | ION-A | Laponite ® OG hectorite | 2-pass | 307.3 | 16.7 | 68.9 | 2.09 | 1.51 | 0.80 |
| CE29 | ION-B | — | **** | 205.2 | 14.5 | 94.5 | 1.40 | 1.31 | 1.10 |
| 86 | ION-B | Cloisite ® Na⁺ MMT, | 1-pass | 302.8 | 16.5 | 67.2 | 2.06 | 1.49 | 0.78 |
| 87 | ION-B | Cloisite ® Na⁺ MMT, | 2-pass | 296.7 | 16.5 | 65.1 | 2.02 | 1.49 | 0.76 |
| 88 | ION-B | Laponite ® OG hectorite | 1-pass | 331.1 | 16.8 | 59.5 | 2.25 | 1.51 | 0.69 |
| 89 | ION-B | Laponite ® OG hectorite | 2-pass | 319.4 | 16.5 | 60.0 | 2.17 | 1.49 | 0.70 |

* LLDPE NA-206 feedstock
** LLDPE NA-206 extruded
*** 80 LLDPE/20 ION-A
**** 80 LLDPE/20 ION-B

Extruded pellet samples were dried and injection molded into ASTM tensile bars using the same procedures described in Example P. All compositions could be injection molded or made into films using conventional melt processing equipment operating under conditions recommended for commercial LLDPE resins. Tensile bars exhibited no defects (flash, sink marks, flow marks, and the like) that could be induced by significant increases in melt viscosity, or by excessive levels of moisture, entrapped air, or other volatile gases.

The various layered silicate masterbatch concentrates made by the 1-pass and 2-pass methods were melt compounded in a letdown step into a LLDPE resin. Table XXXV further lists measured tensile properties for the various composites wherein 1-pass and 2-pass ionomer concentrates containing 20 wt. % MMT or synthetic hectorite were let down into the LLDPE at a concentration of 5 wt. % of the layered silicate (Examples 82-89). TABLE XXXV also reports mechanical properties for Comparative Examples CE26 and CE27 (LLDPE feedstock before and after extrusion) and Comparative Examples CE28 and 29 (LLDPE/20 wt. % ionomer-blend control samples). The TEM image of Example 84 in FIG. 23 shows a phase-separated morphology, in which the ionomer from the masterbatch is largely present in micron-scale domains distributed in the LLDPE matrix. The ionomer domains in turn contain partially exfoliated synthetic hectorite, likely representing most or all of the hectorite introduced via the masterbatch.

The Young's modulus increased by approximately 40% and the yield stress increased by 24 to 32% in the polymer blend controls over the comparable values in the LLDPE host polymer feedstock. There was little change to the elongation at break. The Young's modulus was increased a factor of 1.95 to 2.25, the yield stress was increased by approximately 50%, and the elongation at break was reduced by 20 to 26%, with the addition of the MMT or synthetic hectorite masterbatches. There was very little difference in tensile properties between samples made from the 1-pass or 2-pass masterbatch methods.

Optical data for Examples 82-89 are provided in Table XXXVI. Compared to other host polymers described in the examples above, the raw LLDPE feedstock exhibited significant haze both in samples prepared both with the as-received pellets and after extrusion, although no appreciable color (Comparative Example CE26 and CE27) using the semi-quantitative haze and color evaluation method. Blending the unfilled ionomer with the host polymer (Comparative Examples CE28 and CE29) did not degrade the color and had only a minor effect on haze. All the tensile bar samples containing MMT had significant coloration and were opaque. Compared to the unfilled controls, the tensile bars containing synthetic hectorite all had no appreciable color, but the haze was little changed within the ranking levels.

TABLE XXXVI
Composition and Tensile Properties of Immiscible Multipolymer
Composites Comprising Ionomers and Platy Nanofillers

| | Carrier | | Masterbatch | Color | Haze |
|---|---|---|---|---|---|
| Ex. No. | Polymer | Filler | Processing | Code | Code |
| CE26 | — | — | * | 0 | 4 |
| CE27 | — | — | ** | 0 | 4 |
| CE28 | ION-A | — | *** | 0 | 4.5 |
| 82 | ION-A | Cloisite ® Na⁺ MMT, | 1-pass | 3 | 5 |
| 83 | ION-A | Cloisite ® Na⁺ MMT, | 2-pass | 3 | 4 |
| 84 | ION-A | Laponite ® OG hectorite | 1-pass | 0 | 4 |
| 85 | ION-A | Laponite ® OG hectorite | 2-pass | 0 | 4 |
| CE29 | ION-B | — | **** | 0 | 5 |
| 86 | ION-B | Cloisite ® Na⁺ MMT, | 1-pass | 3 | 5 |
| 87 | ION-B | Cloisite ® Na⁺ MMT, | 2-pass | 3 | 5 |
| 88 | ION-B | Laponite ® OG hectorite | 1-pass | 0 | 4 |
| 89 | ION-B | Laponite ® OG hectorite | 2-pass | 0 | 4 |

* LLDPE NA-206 pellet feedstock (no filler)
** LLDPE NA-206 extruded pellets (no filler)
*** 80 LLDPE/20 ION-A
**** 80 LLDPE/20 ION-B

This example demonstrates that water-dispersible ionomer and unmodified, hydrophilic layered silicates can be dispersed effectively using the melt compounding with water injection and removal method to produce masterbatch concentrates that can be let down in a subsequent melt compounding step to make partially exfoliated composites in immiscible matrix (host) polymers. The resulting multipolymer composites include, in various embodiments, materials that exhibit useful mechanical and/or optical properties.

### Example AG

### Preparation of a Nanocomposite Comprising a Platy Silicate Nanofiller in a Neutralized Poly(Methyl Methacrylate-Methacrylic Acid)

### Comparative Example CE30

A 500-ml, 3-necked round-bottom flask was equipped with a mechanical stirrer and 100.0 g of deionized water added to it. As the water was stirred, 0.77 g of potassium hydroxide (EMD) was added, the stirring continued until it dissolved at room temperature. To the stirred solution was added sequentially 100.0 g of isopropyl alcohol (BDH, 99+%) and 9.91 g of poly(methyl methacrylate/methacrylic acid), with an 80:30 monomer ratio (Polysciences, catalog #08221-100). The mixture was stirred for 30 minutes at room temperature, then heated to 75-78° C. for about 90 minutes to dissolve the polymer, yielding a hazy solution. The solution was cooled to room temperature. While the solution was very rapidly stirred to generate a vortex to wet out the powder before it could form clumps, 1.00 g of Laponite® OG was added. The mixture was stirred rapidly for 30 minutes to thoroughly disperse the Laponite®. The mixture was transferred to a 2-liter round-bottom flask and attached to a rotary evaporator to be dried, with vacuum and heat from a water bath initially set at 65° C. and gradually raised to a maximum 85° C., to avoid a bumping problem associated with water. The solid product was dried overnight at 50° C. in a vacuum oven with a slight nitrogen bleed.

The TEM image in FIG. 24 shows that the Laponite® nanofiller was very poorly dispersed and formed very large agglomerates in the polymer, thus demonstrating that a nanofiller cannot necessarily be well-dispersed and well-exfoliated in an anionic polymer. In contrast, Example A is representative, demonstrating that the same Laponite® OG nanofiller can be well dispersed in nanocomposites based on certain copolymers of α-olefins and α,β-ethylenically unsaturated carboxylic acids, using comparable processing techniques.

Having thus described the invention in rather full detail, it will be understood that such detail need not be strictly adhered to, but that additional changes and modifications may suggest themselves to one skilled in the art. Other methods and materials similar or equivalent to those described herein can be used in the practice or testing of the invention. For example, additional additives known for use in ionomers to aid in processing or to enhance properties may be added at various stages of producing the present composite body. It is to be understood that the present manufacturing process may be implemented in various ways, using different equipment and carrying out the steps described herein in different orders. All of these changes and modifications are to be understood as falling within the scope of the invention as defined by the subjoined claims.

In addition to vendors named elsewhere herein, various materials suitable for use herein may be made by processes known in the art, and/or are available commercially from a variety of suppliers.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value. In addition, unless explicitly stated otherwise or indicated to the contrary by the context of usage, amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value.

Each of the formulae shown herein describes each and all of the separate, individual compounds or monomers that can be assembled in that formula by (1) selection from within the prescribed range for one of the variable radicals, substituents or numerical coefficients while all of the other variable radicals, substituents or numerical coefficients are held constant, and (2) performing in turn the same selection from within the prescribed range for each of the other variable radicals, substituents or numerical coefficients with the others being held constant. In addition to a selection made within the prescribed range for any of the variable radicals, substituents or numerical coefficients of only one of the members of the group described by the range, a plurality of compounds or monomers may be described by selecting more than one but less than all of the members of the whole group of radicals, substituents or numerical coefficients. When the selection made within the prescribed range for any of the variable radicals, substituents or numerical coefficients is a subgroup containing (i) only one of the members of the whole group described by the range, or (ii) more than one but less than all of the members of the whole group, the selected member(s) are selected by omitting those member(s) of the whole group that are not selected to form the subgroup. The compound, monomer, or plurality of compounds or monomers, may in such event be characterized by a definition of one or more of the variable radicals, substituents or numerical coefficients that refers to the whole group of the prescribed range for that variable but where the member(s) omitted to form the subgroup are absent from the whole group.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

What is claimed is:

1. A composition of matter comprising:
(a) an ionomer composition comprising a parent acid copolymer that comprises copolymerized units of an α-olefin having 2 to 10 carbons and units of an α,β-ethylenically unsaturated carboxylic acid having 3 to 8 carbons, wherein a portion of the carboxylic acid groups of the parent acid copolymer are neutralized to form carboxylate salts with monovalent metal cations, ammonium cations, or any mixture thereof; and
(b) a filler material comprising hydrophilic nanoparticles that are substantially free of organoammonium, organophosphonium, and organosulfonium compounds,
and wherein the ionomer composition and the filler are mutually dispersible in an aqueous medium.

2. The composition of matter of claim 1, wherein the α-olefin units of the parent acid copolymer are ethylene.

3. The composition of matter of claim 1, wherein the ethylenically unsaturated carboxylic acid units are comprised of at least one of acrylic acid, methacrylic acid, or a mixture thereof.

4. The composition of matter of claim 1, wherein the ionomer composition comprises about 18 to about 30 weight % of copolymerized units of at least one of acrylic acid, methacrylic acid, or a mixture thereof, based on the total weight of the parent acid copolymer.

5. The composition of matter of claim 1, wherein about 40% to about 100% of the carboxylic acid groups of the copolymer, as calculated based on the total carboxylic acid content of the un-neutralized parent acid copolymer, are neutralized to carboxylic acid salts.

6. The composition of matter of claim 1, wherein the cations are Na⁺ or K⁺ cations or a mixture thereof.

7. The composition of matter of claim 1, wherein the filler comprises at least one of a natural or synthetic layered silicate, graphene oxide, or reduced graphite or graphene oxide.

8. The composition of matter of claim 7, wherein the nanoparticles comprise platy silicate particles.

9. The composition of matter of claim 8, wherein the filler comprises a synthetic, layered, hydrous magnesium lithium silicate comprising platy particles having the approximate empirical chemical formula:
Na⁺_{0.7}[(Si₈Mg_{5.5}Li_{0.3})O₂₀(OH)₄]^{-0.7},
wherein fluoride anions are optionally substituted for at least a portion of the hydroxyl groups.

10. The composition of matter of claim 8, wherein at least about 25% by weight of the nanoparticles are exfoliated or present in tactoids less than 20 nm thick.

11. The composition of matter of claim 7, wherein the nanoparticles comprise natural or synthetic rod-, needle-, or ribbon-like silicate particles.

12. The composition of matter of claim 7, wherein the nanoparticles have a cation exchange capacity of less than 80 milliequivalents/100 g.

13. The composition of matter of claim 1, wherein the filler comprises at least one of SiO₂ nanoparticles, TiO₂ nanoparticles, ZnO nanoparticles, ZrO₂ nanoparticles, or carbon nanotubes.

14. The composition of matter of claim 13, wherein the nanoparticles comprise colloidal SiO₂ nanoparticles having negative or neutral surface charge.

15. The composition of matter of claim 1, wherein the ionomer composition and the filler material are dispersed in an aqueous medium comprising water and optionally one or more polar organic solvents including up to 75 wt. % of one or more alcohols having 1 to 5 carbon atoms or up to 50 wt. % of one or more of dimethylformamide (DMF), dimethylacetamide (DMAc), n-methylpyrrolidone (NMP), and formamide.

16. The composition of matter of claim 1, comprising 0.5 to 20 wt. % of the nanoparticles.

17. The composition of matter of claim 1, wherein the ionomer composition comprises a plurality of ionomers each comprising copolymerized units of an α-olefin having 2 to 10 carbons and units of an α,β-ethylenically unsaturated carboxylic acid having 3 to 8 carbons, wherein a portion of the carboxylic acid groups of the parent acid copolymer are neutralized by cations to form carboxylate salts, the cations being monovalent metal cations, ammonium cations, or any mixture thereof.

18. An ionomer composite comprising the composition of matter of claim 1.

19. An article of manufacture comprising the composition of matter of claim 1.

20. A multipolymer composite, comprising:
(a) a host polymer; and
(b) the composition of matter of claim 1,
wherein the ionomer composition and the filler of the composition of matter are dispersed in the host polymer.

21. The multipolymer composite of claim 20, wherein the host polymer is a host acid copolymer comprising copolymerized units of an α-olefin having 2 to 10 carbons and units of an α,β-ethylenically unsaturated carboxylic acid having 3 to 8 carbons, or a host ionomer derived from said host acid copolymer wherein at least a portion of the unsaturated carboxylic acid groups of the host acid copolymer are neutralized to form carboxylate salts with host cations.

22. The multipolymer composite of claim 20, wherein the ionomer composition and host polymer are melt-miscible.

23. The multipolymer composite of claim 20, wherein the host polymer and the ionomer composition are immiscible.

24. The multipolymer composite of claim 20, wherein the host polymer is a polymer compatible with the ionomer composition.

25. An article of manufacture comprising the multipolymer composite of claim 20.
